(19) United States
(12) Patent Application Publication
(10) Pub. No.: US 2016/0118689 A1
(43) Pub. Date: Apr. 28, 2016

(54) LITHIUM-ION STORAGE BATTERY

(71) Applicant: SEMICONDUCTOR ENERGY LABORATORY CO., LTD., Atsugi-shi (JP)

(72) Inventors: Teppei OGUNI, Atsugi (JP); Kazutaka KURIKI, Ebina (JP); Ai NAKAGAWA, Sagamihara (JP); Aya UCHIDA, Isehara (JP)

(21) Appl. No.: 14/919,943

(22) Filed: Oct. 22, 2015

(30) Foreign Application Priority Data
Oct. 24, 2014 (JP) 2014-217667

(51) Int. Cl. H01M 10/0568; H01M 4/58; H01M 10/0569; H01M 4/66; H01M 10/0525; H01M 4/136; H01M 4/62

(52) U.S. Cl. CPC H01M 10/0568; H01M 4/136; H01M 4/5825; H01M 4/625; H01M 4/661; H01M 10/0525; H01M 10/0569; H01M 2004/028

(57) ABSTRACT

A lithium-ion storage battery with a favorable cycle life at high temperatures is provided. A lithium-ion storage battery with a longer lifetime due to reduction of the capacity decrease is provided. A lithium-ion storage battery where reaction between a positive electrode active material and an electrolyte in an electrolyte solution is inhibited is provided. One embodiment of the present invention is a lithium-ion storage battery including a positive electrode, a negative electrode, an electrolyte solution. The positive electrode includes an active material, the active material includes a metal, and the electrolyte solution includes at least one of LiTFSA and LiFSA. Note that, in the lithium-ion storage battery of one embodiment of the present invention, the positive electrode may include a current collector, and the current collector may include Al. In the lithium-ion storage battery, the electrolyte solution may further include LiPF₆.

### BACKGROUND OF THE INVENTION

1. Field of the Invention

One embodiment of the present invention relates to a lithium-ion storage battery and a method for fabricating the lithium-ion storage battery.

Note that one embodiment of the present invention is not limited to the above technical field. The technical field of one embodiment of the invention disclosed in this specification and the like relates to an object, a method, or a fabricating method. In addition, one embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a memory device, an imaging device, a method for driving any of them, and a method for fabricating any of them.

2. Description of the Related Art

Examples of the storage battery include a nickel-metal hydride battery, a lead-acid battery, and a lithium-ion storage battery.

Such storage batteries are used as power sources in portable information terminals typified by mobile phones. In particular, lithium-ion storage batteries have been actively developed because the capacity thereof can be increased and the size thereof can be reduced. The performance required for the lithium-ion storage batteries includes increased energy density, improved cycle life, safe operation under a variety of environments, and longer-term reliability.

In general, a lithium-ion storage battery includes components such as a positive electrode, a negative electrode, an electrolyte solution, a separator, and an exterior body. The positive electrode and the negative electrode each include a current collector, and also include an active material in some cases. These components affect the performance of lithium-ion storage batteries, and therefore have been actively developed to improve the performance. In addition, in order to improve the performance of the storage batteries, a process for incorporating the components in the storage batteries has also been actively developed.

Examples of the known materials for a positive electrode active material are phosphate compounds having an olivine crystal structure and containing lithium and iron, manganese, cobalt, or nickel, such as lithium iron phosphate (LiFePO₄), lithium manganese phosphate (LiMnPO₄), lithium cobalt phosphate (LiCoPO₄), and lithium nickel phosphate (LiNiPO₄) (Patent Document 1, Non-Patent Document 1, and Non-Patent Document 2).

In the lithium-ion storage battery, a material which transfers carrier ions and contains carrier ions is used as an electrolyte in the electrolyte solution. Typical examples of the solvent are lithium salts such as LiPF₆, LiClO₄, Li(FSO₂)₂N, LiAsF₆, LiBF₄, LiCF₃SO₃, Li(CF₃SO₂)₂N, and Li(C₂F₅SO₂)₂N.

### REFERENCE

### Patent Document

[Patent Document 1] Japanese Published Patent Application No. H11-25983

### Non-Patent Document

[Non-Patent Document 1] Byoungwoo Kang, Gerbrand Ceder, “Nature,” 2009, Vol. 458 (12), pp. 190-193
[Non-Patent Document 2] F. Zhou et al., “Electrochemistry Communications,” 2004, Vol. 6, pp. 1144-1148

### SUMMARY OF THE INVENTION

As a positive electrode active material, a material selected from the above is used and, as an electrolyte in the electrolyte solution, a material selected from the above is used. A lithium-ion storage battery using the materials is assembled and subjected to a cycle life test at high temperatures. The results reveal that the deterioration progresses rapidly beyond expectation and the capacity retention rate significantly decreases in some cases.

The storage battery subjected to the above cycle life test is disassembled and the components are analyzed. A metal used for the positive electrode active material is detected from a surface of a negative electrode. This indicates that a part of the metal in the positive electrode active material is dissolved in the electrolyte solution by a reaction between the electrolyte solution and the positive electrode active material or by a reaction between the decomposition product of the electrolyte solution and the positive electrode active material, and the metal is deposited on the surface of the negative electrode during repeated charging and discharging. It is found that the capacity of the storage battery decreases because the positive electrode active material deteriorates and charge is wasted due to the deposition of the metal on the negative electrode. Specifically, since it is known that lithium hexafluorophosphate (LiPF₆) used for the electrolyte solution produces HF by hydrolysis, the hydrolysis of LiPF₆ occurs in the high-temperature cycle operation and the produced HF reacts with the positive electrode, which possibly reduces the capacity of the storage battery.

In view of the above, an object of one embodiment of the present invention is to provide a lithium-ion storage battery with a favorable cycle life at high temperatures. Another object is to provide a lithium-ion storage battery with a longer lifetime due to reduction of the capacity decrease. Another object is to provide a lithium-ion storage battery where reaction between a positive electrode active material and an electrolyte solution is inhibited. Another object is to provide a lithium-ion storage battery where deterioration of a positive electrode active material is inhibited. Another object is to provide a lithium-ion storage battery where deposition of a metal on a surface of a negative electrode is inhibited. Another object is to provide a lithium-ion storage battery where battery reaction hindered due to the reaction between a positive electrode active material and an electrolyte solution is inhibited. Another object of one embodiment of the present invention is to provide a method for fabricating a lithium-ion storage battery with a favorable cycle life at high temperatures. Another object of one embodiment of the present invention is to provide a method for fabricating a lithium-ion storage battery where battery reaction hindered due to the reaction between the positive electrode active material and the electrolyte solution is inhibited. Another object of one embodiment of the present invention is to provide a novel storage battery, a novel power storage device, a novel method for fabricating a storage battery, or a novel method for fabricating a power storage device.

Note that the description of these objects does not disturb the existence of other objects. In one embodiment of the present invention, there is no need to achieve all the objects. Other objects will be apparent from and can be derived from the description of the specification, the drawings, the claims, and the like.

One embodiment of the present invention is a lithium-ion storage battery including a positive electrode, a negative electrode, and an electrolyte solution. The positive electrode includes an active material, and the active material includes a metal. The electrolyte solution includes at least one of lithium bis(trifluoromethanesulfonyl)amide (LiTFSA) and lithium bis(fluorosulfonyl)amide (LiFSA).

Note that, in the lithium-ion storage battery of one embodiment of the present invention, the positive electrode may include a current collector, and the current collector may include Al. In the lithium-ion storage battery, the electrolyte solution may further include LiPF₆. In the lithium-ion storage battery, the metal included in the active material of the positive electrode may not be observed by an X-ray photoelectron spectroscopy performed on the surface of the negative electrode. In the lithium-ion storage battery, the metal may be any one of Fe, Co, Ni, or Mn. In a lithium-ion storage battery of one embodiment of the present invention, a positive electrode, a negative electrode, and an electrolyte solution are provided, the positive electrode includes an active material, the active material includes a metal, and the electrolyte solution includes Li, N, F, S, O, and C.

In the lithium-ion storage battery of one embodiment of the present invention, reaction between a material for an active material of the positive electrode and the electrolyte solution is inhibited, and deposition of the metal included in the active material of the positive electrode on the surface of the negative electrode is inhibited. In a cycle life test, the deterioration mildly progresses and a favorable capacity retention rate is achieved. The lithium-ion storage battery has a long lifetime.

Therefore, one embodiment of the present invention can provide a lithium-ion storage battery with a favorable cycle life at high temperatures. A lithium-ion storage battery with a longer lifetime due to reduction of the capacity decrease can be provided. A lithium-ion storage battery where reaction between a positive electrode active material and an electrolyte solution is inhibited can be provided. A lithium-ion storage battery where deterioration of a positive electrode active material is inhibited can be provided. A lithium-ion storage battery where deposition of a metal on a surface of a negative electrode is inhibited can be provided. A lithium-ion storage battery where battery reaction hindered due to the reaction between a positive electrode active material and an electrolyte solution is inhibited can be provided. One embodiment of the present invention can provide a method for fabricating a lithium-ion storage battery with a favorable cycle life at high temperatures. One embodiment of the present invention can provide a method for fabricating a lithium-ion storage battery where battery reaction hindered due to the reaction between the positive electrode active material and the electrolyte solution is inhibited. One embodiment of the present invention can provide a novel storage battery, a novel power storage device, a novel method for fabricating a storage battery, or a novel method for fabricating a power storage device.

Note that the description of these effects does not disturb the existence of other effects. In one embodiment of the present invention, there is no need to obtain all the above effects. Other effects are apparent from and can be derived from the description of the specification, the drawings, the claims, and the like.

### BRIEF DESCRIPTION OF THE DRAWINGS

In the accompanying drawings:

FIGS. 1A and 1B illustrate a lithium-ion storage battery according to one embodiment of the present invention;

FIGS. 2A to 2D illustrate curvature radii;

FIGS. 3A to 3C illustrate a curvature radius;

FIGS. 4A to 4C illustrate a coin-type storage battery;

FIGS. 5A and 5B illustrate a cylindrical storage battery;

FIGS. 6A and 6B illustrate a laminated storage battery;

FIG. 7 is an external view of a storage battery;

FIG. 8 is an external view of a storage battery;

FIGS. 9A to 9C illustrate a method for fabricating a storage battery;

FIGS. 10A to 10E illustrate flexible laminated storage batteries;

FIGS. 11A and 11B illustrate examples of power storage devices;

FIGS. 12A1, 12A2, 12B1, and 12B2 illustrate examples of power storage devices;

FIGS. 13A and 13B illustrate examples of power storage devices;

FIGS. 14A and 14B illustrate examples of power storage devices;

FIG. 15 illustrates an example of a power storage device;

FIGS. 16A and 16B illustrate application examples of power storage devices;

FIG. 17 shows a cycle performance of a storage battery 1 and a comparative storage battery 1;

FIG. 18 shows the XPS spectrum of a negative electrode included in the comparative storage battery 1;

FIG. 19 shows the XPS spectrum of a negative electrode included in the storage battery 1;

FIG. 20 is a cross-sectional TEM observation image of the vicinity of a surface of a positive electrode active material included in the comparative storage battery 1;

FIG. 21 is a cross-sectional TEM observation image of the vicinity of a surface of a positive electrode active material included in the storage battery 1;

FIG. 22 shows temperature characteristics of a storage battery 2;

FIG. 23 is a block diagram illustrating one embodiment of the present invention;

FIGS. 24A to 24C are each a schematic view illustrating one embodiment of the present invention;

FIG. 25 is a circuit diagram illustrating one embodiment of the present invention;

FIG. 26 is a circuit diagram illustrating one embodiment of the present invention;

FIGS. 27A to 27C are each a schematic view illustrating one embodiment of the present invention;

FIG. 28 is a block diagram illustrating one embodiment of the present invention; and

FIG. 29 is a flow chart showing one embodiment of the present invention.

### DETAILED DESCRIPTION OF THE INVENTION

Embodiments of the present invention will be described below. However, the present invention is not limited to the description below, and it is easily understood by those skilled in the art that modes and details disclosed herein can be modified in various ways. Therefore, the present invention is not construed as being limited to the description of the embodiments and the examples.

Note that the terms “film” and “layer” can be interchanged with each other depending on the case or circumstances. For example, the term “conductive layer” can be changed into the term “conductive film” in some cases. Also, the term “insulating film” can be changed into the term “insulating layer” in some cases.

Note that in each drawing described in this specification, the size, the thickness, or the like of each component such as a positive electrode, a negative electrode, an active material layer, a separator, an exterior body, and the like is exaggerated for clarity in some cases. Therefore, the sizes of the components are not limited to the sizes in the drawings and relative sizes between the components.

Note that in the structures of one embodiment of the present invention described in this specification and the like, the same portions or portions having similar functions in different drawings are denoted by the same reference numerals, and description of such portions is not repeated. Furthermore, the same hatching pattern is applied to portions having similar functions, and the portions are not especially denoted by reference numerals in some cases.

The descriptions in embodiments for the present invention can be combined with each other as appropriate.

### Embodiment 1

In this embodiment, a lithium-ion storage battery of one embodiment of the present invention is described.

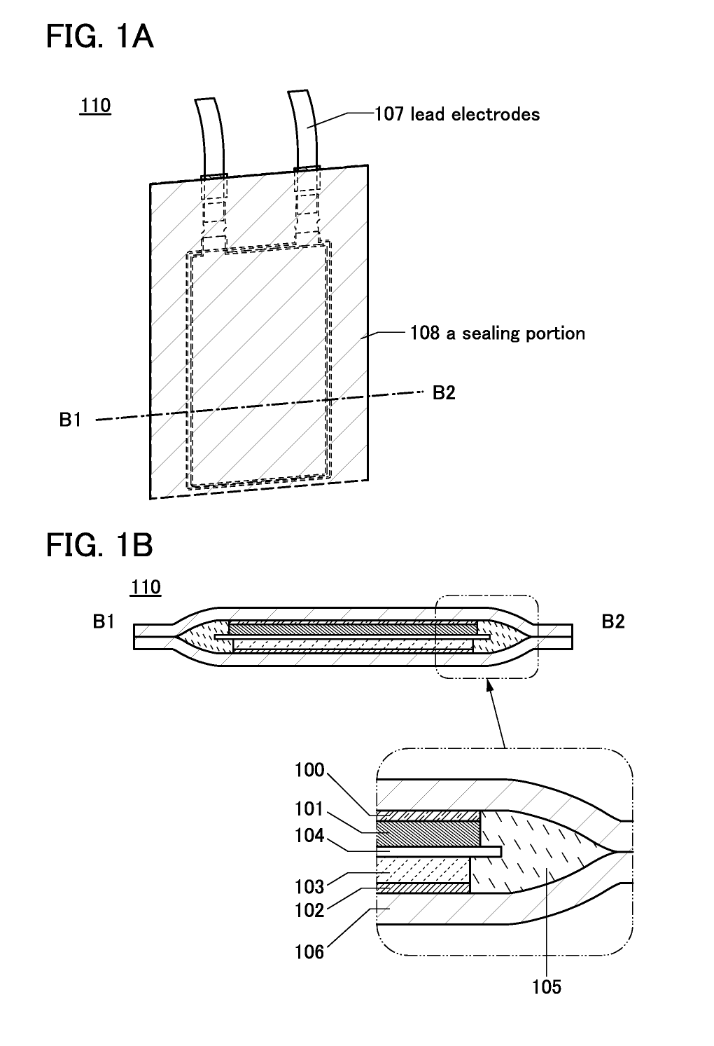

A method for fabricating a lithium-ion storage battery 110 of one embodiment of the present invention is described below using FIGS. 1A and 1B. FIG. 1A is a schematic view of the lithium-ion storage battery 110 in which lead electrodes 107 are exposed to the outside of an exterior body 106. FIG. 1B is a schematic cross-sectional view of the lithium-ion storage battery 110 taken along dashed-dotted line B1-B2. In the schematic cross-sectional view, a positive electrode current collector 100, a positive electrode active material layer 101, a separator 104, a negative electrode active material layer 103, and a negative electrode current collector 102 are stacked and, together with an electrolyte solution 105, enclosed by an exterior body 106. Note that the active material layers can be formed on both surfaces of the current collector, and the storage battery can have a stacked-layer structure.

### <Structure of Positive Electrode>

The positive electrode is described. The positive electrode includes the positive electrode active material layer 101 and the positive electrode current collector 100.

As a material for a positive electrode active material used for the positive electrode active material layer 101, a material into and from which carrier ions such as lithium ions can be inserted and extracted can be used. Examples of the material are a lithium-containing material with an olivine crystal structure, a layered rock-salt crystal structure, and a spinel crystal structure, and the like.

Typical examples of the lithium-containing material with an olivine crystal structure (general formula: LiMPO₄ (M is Fe(II), Mn(II), Co(II), or Ni(II))) are LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), LiFe_{f}Ni_{g}CoₕMnᵢPO₄ (f+g+h+i≦1, 0<f<1, 0<g<1, 0<h<1, and 0<i<1), and the like.

For example, lithium iron phosphate (LiFePO₄) is particularly preferable because it properly has properties necessary for the positive electrode active material, such as safety, stability, high capacity density, high potential, and the existence of lithium ions that can be extracted in initial oxidation (charge).

Examples of the lithium-containing material with a layered rock-salt crystal structure include lithium cobalt oxide (LiCoO₂); LiNiO₂; LiMnO₂; Li₂MnO₃; an NiCo-based lithium-containing material (general formula: LiNiₓCo₁₋ₓO₂ (0<x<1)) such as LiNi_{0.8}Co_{0.2}O₂; an NiMn-based lithium-containing material (general formula: LiNiₓMn₁₋ₓO₂ (0<x<1)) such as LiNi_{0.5}Mn_{0.5}O₂; and an NiMnCo-based lithium-containing material (also referred to as NMC, and general formula: LiNiₓMn_{y}Co_{1-x-y}O₂ (x>0, y>0, x+y<1)) such as LiNi_{1/3}Mn_{1/3}CO_{1/3}O₂. Moreover, Li(Ni_{0.8}Co_{0.15}Al_{0.05})O₂, Li₂MnO₃-LiMO₂ (M is Co, Ni, or Mn), and the like can be given.

In particular, LiCoO₂ is preferable because it has high capacity, higher stability in the air than that of LiNiO₂, and higher thermal stability than that of LiNiO₂, for example.

Examples of the lithium-containing material with a spinel crystal structure are LiMn₂O₄, Li₁₊ₓMn₂₋ₓO₄ (0<x<2), LiMn₂₋ₓAlₓO₄ (0<x<2), LiMn_{1.5}Ni_{0.5}O₄, and the like.

It is preferable to add a small amount of lithium nickel oxide (LiNiO₂ or LiNi₁₋ₓMₓO₂ (M is Co, Al, or the like, 0<x<1)) to the lithium-containing material with a spinel crystal structure which contains manganese such as LiMn₂O₄, in which case the dissolution of manganese and the decomposition of an electrolyte solution can be suppressed, for example.

A composite oxide expressed by Li₍₂₋ⱼ₎MSiO₄ (general formula) (M is Fe(II), Mn(II), Co(II), or Ni(II), 0≦j≦2) can also be used as the positive electrode active material. Typical examples of the general formula Li₍₂₋ⱼ₎MSiO₄ include Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNi/SiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

Alternatively, a nasicon compound represented by a general formula AₓM₂(XO₄)₃ (A is Li, Na, or Mg, M is Fe, Mn, Ti, V, Nb, or Al, and X is S, P, Mo, W, As, or Si) can be used as the positive electrode active material. Examples of the nasicon compound are Fe₂(MnO₄)₃, Fe₂(SO₄)₃, Li₃Fe₂(PO₄)₃, and the like. Further alternatively, a compound represented by a general formula Li₂MPO₄F, Li₂MP₂O₇, or Li₅MO₄ (M is Fe or Mn), a perovskite fluoride such as MnF₃ or FeF₃, a metal chalcogenide (a sulfide, a selenide, or a telluride) such as TiS₂ or MoS₂, a lithium-containing material with an inverse spinel crystal structure such as LiMVO₄, a vanadium oxide (V₂O₅, V₆O₁₃, LiV₃O₈, or the like), a manganese oxide, an organic sulfur compound, or the like can be used as the positive electrode active material.

In the case where carrier ions are alkali metal ions other than lithium ions, or alkaline-earth metal ions, the positive electrode active material may contain, instead of lithium in the compound and the oxide, an alkali metal (e.g., sodium or potassium), an alkaline-earth metal (e.g., calcium, strontium, barium, beryllium, or magnesium). For example, the positive electrode active material may be a layered oxide containing sodium such as NaFeO₂ or Na_{2/3} [Fe_{1/2}Mn_{1/2}]O₂.

Further alternatively, any of the aforementioned materials may be combined to be used as the positive electrode active material. For example, a solid solution obtained by combining two or more of the above materials can be used as the positive electrode active material. For example, a solid solution of LiCo_{1/3}Mn_{1/3}Ni_{1/3}O₂ and Li₂MnO₃ can be used as the positive electrode active material.

The average particle diameter of the primary particle of the positive electrode active material is preferably greater than or equal to 50 nm and less than or equal to 100 μm.

The positive electrode active material and a negative electrode active material have a central role in battery reactions of a storage battery, and occlude and release carrier ions. To increase the lifetime of storage battery, the substances preferably have a small amount of capacity which relates to irreversible battery reactions, and have high charge and discharge efficiency.

The active material is in contact with an electrolyte solution. When the active material reacts with the electrolyte solution, the active material is lost and deteriorates by the reaction, which decreases the capacity of the storage battery. Therefore, it is preferable that such a reaction not be caused in the storage battery in order to achieve a storage battery which hardly deteriorates. A method for inhibiting the reaction will be described later.

Examples of the conductive additive in the electrode include acetylene black (AB), graphite (black lead) particles, carbon nanotubes, graphene, and fullerene.

A network for electric conduction can be formed in the electrode by the conductive additive. The conductive additive also allows maintaining of a path for electric conduction between the particles of the positive electrode active material. The addition of the conductive additive to the positive electrode active material layer increases the electric conductivity of the positive electrode active material layer 101.

A typical example of the binder is polyvinylidene fluoride (PVDF), and other examples of the binder include polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, and nitrocellulose.

The content of the binder in the positive electrode active material layer 101 is preferably greater than or equal to 1 wt % and less than or equal to 10 wt %, further preferably greater than or equal to 2 wt % and less than or equal to 8 wt %, and still further preferably greater than or equal to 3 wt % and less than or equal to 5 wt %. The content of the conductive additive in the positive electrode active material layer 101 is preferably greater than or equal to 1 wt % and less than or equal to 10 wt %, and further preferably greater than or equal to 1 wt % and less than or equal to 5 wt %.

In the case where the positive electrode active material layer 101 is formed by a coating method, the positive electrode active material, the binder, the conductive additive, and a dispersion medium are mixed to form a slurry, and the slurry is applied to the positive electrode current collector 100 and dried. In this embodiment, a metal material including aluminum as its main component is preferably used as the positive electrode current collector 100.

The positive electrode current collector 100 can be formed using a material, which has high conductivity and is not alloyed with carrier ions of lithium or the like, such as stainless steel, gold, platinum, aluminum, or titanium, or an alloy thereof. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The positive electrode current collector can have a foil shape, a plate (sheet) shape, a net shape, a punching-metal shape, an expanded-metal shape, or the like as appropriate.

Through the above steps, the positive electrode of the lithium-ion storage battery can be formed.

### <Structure of Negative Electrode>

Next, the negative electrode is described with reference to FIG. 1B. The negative electrode includes the negative electrode active material layer 103 and the negative electrode current collector 102. Steps of forming the negative electrode are described below.

Examples of the carbon-based material as the negative electrode active material used for the negative electrode active material layer 103 include graphite, graphitizing carbon (soft carbon), non-graphitizing carbon (hard carbon), a carbon nanotube, graphene, and carbon black. Examples of graphite include artificial graphite such as meso-carbon microbeads (MCMB), coke-based artificial graphite, and pitch-based artificial graphite and natural graphite such as spherical natural graphite. In addition, the shape of the graphite is a flaky shape or a spherical shape, for example.

Other than the carbon-based material, a material which enables charge-discharge reactions by an alloying reaction and a dealloying reaction with lithium can be used as the negative electrode active material. A material containing at least one of Ga, Si, Al, Ge, Sn, Pb, Sb, Bi, Ag, Zn, Cd, In, and the like can be used, for example. Such elements have higher capacity than carbon. In particular, silicon has a significantly high theoretical capacity of 4200 mAh/g and is preferably used. Examples of an alloy-based material (compound-based material) using such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, for the negative electrode active material, an oxide such as SiO, SnO, SnO₂, titanium dioxide (TiO₂), lithium titanium oxide (Li₄Ti₅O₁₂), lithium-graphite intercalation compound (LiₓC₆), niobium pentoxide (Nb₂O₅), tungsten dioxide (WO₂), or molybdenum dioxide (MoO₂) can be used.

Still alternatively, for the negative electrode active material, Li₃₋ₓMₓN (M is Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

When a nitride including lithium and a transition metal is used, lithium ions are included in the negative electrode active material; thus, the negative electrode active material can be used in combination with a material for a positive electrode active material which does not contain lithium ions, such as V₂O₅ or Cr₃O₈. In the case of using a material containing lithium ions for a positive electrode active material, the nitride containing lithium and a transition metal can be used for the negative electrode active material by extracting the lithium ions contained in the positive electrode active material in advance.

Alternatively, a material which causes a conversion reaction can be used for the negative electrode active material; for example, a transition metal oxide with which an alloying reaction with lithium is not caused, such as cobalt oxide (CoO), nickel oxide (NiO), and iron oxide (FeO), may be used for the negative electrode active material. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

The particle diameter of the negative electrode active material is preferably greater than or equal to 50 nm and less than or equal to 100 μm, for example.

Note that it is acceptable that a plurality of materials for active materials are combined at a given proportion both for the positive electrode active material layer 101 and the negative electrode active material layer 103. The use of a plurality of materials for the active material layer makes it possible to select the performance of the active material layer in detail.

Examples of the conductive additive in the electrode include acetylene black (AB), graphite (black lead) particles, carbon nanotubes, graphene, and fullerene.

A network for electric conduction can be formed in the electrode by the conductive additive. The conductive additive also allows maintaining of a path for electric conduction between the particles of the negative electrode active material. The addition of the conductive additive to the negative electrode active material layer increases the electric conductivity of the negative electrode active material layer 103.

A typical example of the binder is polyvinylidene fluoride (PVDF), and other examples of the binder include polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, and nitrocellulose.

The content of the binder in the negative electrode active material layer 103 is preferably greater than or equal to 1 wt % and less than or equal to 10 wt %, further preferably greater than or equal to 2 wt % and less than or equal to 8 wt %, and still further preferably greater than or equal to 3 wt % and less than or equal to 5 wt %. The content of the conductive additive in the negative electrode active material layer 103 is preferably greater than or equal to 1 wt % and less than or equal to 10 wt %, and further preferably greater than or equal to 1 wt % and less than or equal to 5 wt %.

The negative electrode active material layer 103 is formed over the negative electrode current collector 102. In the case where the negative electrode active material layer 103 is formed by a coating method, the negative electrode active material, the binder, the conductive additive, and a dispersion medium are mixed to form a slurry, and the slurry is applied to the negative electrode current collector 102 and dried. If necessary, pressing may be performed after the drying.

The negative electrode current collector 102 can be formed using a material, which has high conductivity and is not alloyed with carrier ions of lithium or the like, such as stainless steel, gold, platinum, zinc, iron, copper, titanium, or tantalum, or an alloy thereof. Alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The negative electrode current collector 102 can have a foil shape, a plate (sheet) shape, a net shape, a cylindrical shape, a coil shape, a punching-metal shape, an expanded-metal shape, or the like as appropriate. The negative electrode current collector 102 preferably has a thickness greater than or equal to 5 μm and less than or equal to 30 μm. A part of the surface of the electrode current collector may be provided with an undercoat layer using graphite or the like.

Through the above steps, the negative electrode of the lithium-ion storage battery can be formed.

### <Structure of Separator>

The separator 104 is described. The separator 104 may be formed using a material such as paper, nonwoven fabric, a glass fiber, a synthetic fiber such as nylon (polyamide), vinylon (a polyvinyl alcohol based fiber), polyester, acrylic, polyolefin, or polyurethane. However, a material that does not dissolve in an electrolyte solution described later needs to be selected.

More specifically, as a material for the separator 104, polymer compounds based on fluorine-based polymer, polyether such as polyethylene oxide and polypropylene oxide, polyolefin such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane, derivatives thereof, cellulose, paper, nonwoven fabric, and a glass fiber can be used either alone or in combination.

The separator 104 needs to have insulation performance that inhibits connection between the electrodes, performance that holds the electrolyte solution, and ionic conductivity. As a method for forming a film having a function as a separator, a method for forming a film by stretching is given. Examples of the method include a stretching aperture method in which a melted polymer material is spread, heat is released from the material, and pores are formed by stretching the resulting film in the directions of two axes parallel to the film.

To set the separator 104 in a storage battery, a method in which the separator is inserted between the positive electrode and the negative electrode can be used. Alternatively, a method in which the separator 104 is placed on one of the positive electrode and the negative electrode and then the other of the positive electrode and the negative electrode is placed thereon can be used. The positive electrode, the negative electrode, and the separator are stored in the exterior body, and the exterior body is filled with the electrolyte solution, whereby the storage battery can be fabricated.

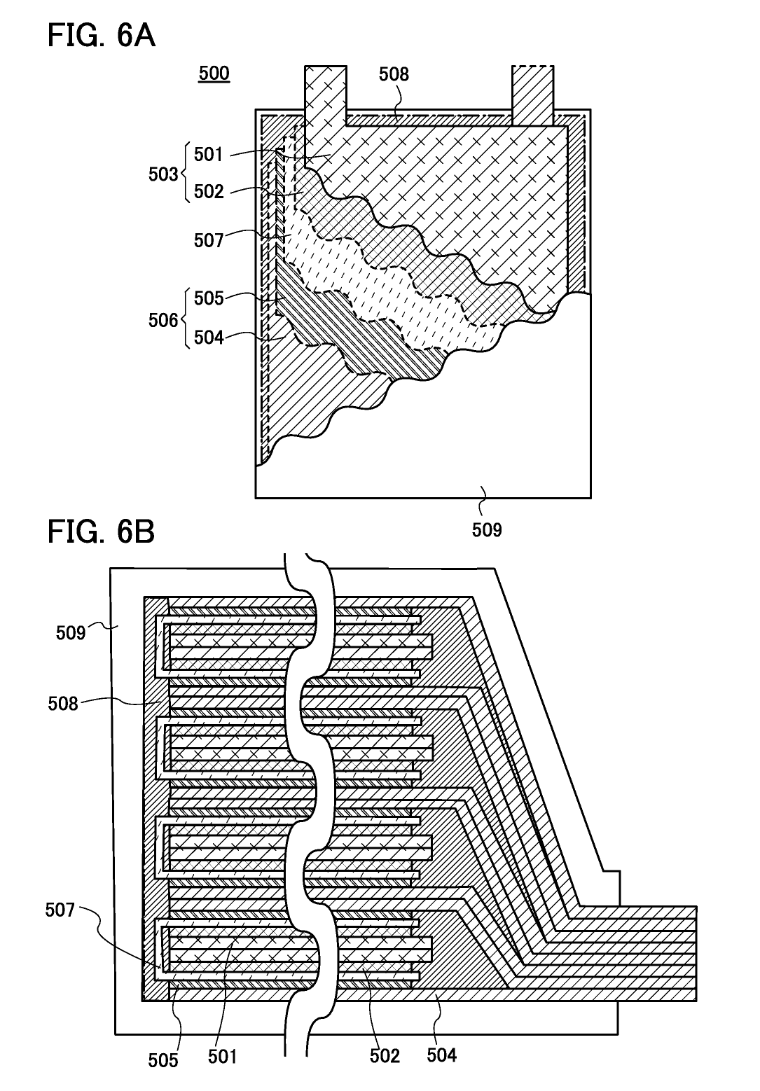

The separator 104 with a size large enough to cover each surface of either the positive electrode or the negative electrode, in a form of sheet or envelope, may be fabricated to form the electrode wrapped in the separator 104. In that case, the electrode can be protected from mechanical damages in the fabrication of the storage battery and the handling of the electrode becomes easier. The electrode wrapped in the separator and the other electrode are stored in the exterior body, and the exterior body is filled with the electrolyte solution, whereby the storage battery can be formed. FIG. 6B is a cross-sectional view of a storage battery with an envelope-like separator 507. FIG. 6B shows the cross-sectional structure of a storage battery with a layered structure including plural pairs of positive and negative electrodes.

The separator may be a plurality of layers. Although the separator can be formed by the above method, the range of the thickness of the film and the size of the pore in the film of the separator is limited by a material of the separator and mechanical strength of the film. A first separator and a second separator each formed by a stretching method may be used together in a storage battery. The first separator and the second separator can be formed using one or more kinds of material selected from the above-described materials or materials other than those described above. Characteristics such as the size of the pore in the film, the proportion of the volume of the pores in the film (also referred to as porosity), and the thickness of the film can be determined by film formation conditions, film stretching conditions, and the like. By using the first separator and the second separator having different characteristics, the performance of the separators of the storage battery can be selected more variously than in the case of using one of the separators.

The storage battery may be flexible. In the case where flow stress is applied to the flexible storage battery, the stress can be relieved by sliding of the first separator and the second separator at the interface between the first separator and the second separator. Therefore, the structure including a plurality of separators is also suitable as a structure of a separator in a flexible storage battery.

Through the above steps, the separator can be incorporated in the lithium-ion storage battery.

### <Components of Electrolyte Solution>

The electrolyte solution 105 used in the lithium-ion storage battery of one embodiment of the present invention is preferably a nonaqueous solution containing an electrolyte.

For a solvent of the electrolyte solution 105, a material in which carrier ions can transfer is used. For example, an aprotic organic solvent is preferably used, and one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

When a gelled polymer material is used as the solvent of the electrolyte solution 105, safety against liquid leakage and the like is improved. Furthermore, the lithium-ion storage battery can be thinner and more lightweight. Typical examples of the gelled polymer material include a silicone gel, an acrylic gel, an acrylonitrile gel, a polyethylene oxide gel, a polypropylene oxide gel, a fluorine-based polymer gel, and the like.

Alternatively, the use of one or more of ionic liquids (room temperature molten salts) that have non-flammability and non-volatility as the solvent for the electrolyte solution can inhibit a lithium-ion storage battery from exploding or catching fire even when the lithium-ion storage battery internally shorts out or the internal temperature increases due to overcharging or the like. Thus, the lithium-ion storage battery has improved safety.

In the storage battery, when a metal included in the positive electrode active material is dissolved by reaction between the electrolyte solution and the active material, the capacity of the storage battery is decreased and the storage battery deteriorates. That is, the capacity is significantly decreased as charging and discharging are repeated through the cycle life test of the storage battery, and the lifetime of the storage battery becomes short. In one embodiment of the present invention, the use of a thermostable material which is less likely to react with the active material for the electrolyte material included in the electrolyte solution makes it less likely to cause the dissolution of the metal in the active material.

Examples of the metal in the materials for the positive electrode active material include Fe, Co, Ni, and Mn. In one embodiment of the present invention, for the electrolyte material used for the electrolyte solution, an electrolyte which is less likely to dissolves these metals included in the positive electrode active material layer 101. Specifically, LiTFSA (lithiumbis(trifluoromethanesulfonyl)amide) and LiFSA (lithium bis(fluorosulfonyl)amide) can be given for the electrolyte which can be used for one embodiment of the present invention. Note that LiTFSA includes Li, N, a trifluoromethyl group, and a sulfonyl group. That is, LiTFSA includes Li, N, F, S, O, and C. LiFSA includes Li, N, F, and a sulfonyl group. That is, LiFSA includes Li, N, F, S, and O.

The electrolyte solution using LiTFSA or LiFSA as the electrolyte, in which the hydrolysis is less likely to occur and which has high thermal stability, inhibits the metal included in the material for the positive electrode active material from dissolving in battery reaction of the storage battery. Therefore, for example, an XPS (X-ray photoelectron spectroscopy) analysis performed on a surface of the negative electrode, which is taken out of the storage battery disassembled after charge and discharge are repeatedly performed, shows that the metal is not observed or the amount of the metal is extremely small.

Therefore, in the storage battery of one embodiment of the present invention, the dissolution of the metal included in the positive electrode active material into the electrolyte solution is inhibited, so that the deterioration of the positive electrode active material is inhibited. In addition, the deposition of the metal on a surface of the negative electrode is inhibited, so that the capacity reduction is small, and the storage battery can have a preferable cycle lifetime.

Although the case where carrier ions are lithium ions in the above electrolyte is described, carrier ions other than lithium ions can be used. When the carrier ions other than lithium ions are alkali metal ions or alkaline-earth metal ions, instead of lithium in the lithium salts, an alkali metal (e.g., sodium or potassium) or an alkaline-earth metal (e.g., calcium, strontium, barium, beryllium, or magnesium) may be used as the electrolyte.

The electrolyte solution used for the storage battery is preferably a highly purified one so as to contain a negligible small amount of dust particles and elements other than the constituent elements of the electrolyte solution (hereinafter, also simply referred to as impurities). Specifically, the mass ratio of impurities to the electrolyte solution is less than or equal to 1%, preferably less than or equal to 0.1%, and further preferably less than or equal to 0.01%. An additive agent such as vinylene carbonate may be added to the electrolyte solution.

With the use of the above solvent and the above electrolyte, an electrolyte solution of the storage battery of one embodiment of the present invention can be formed.

Note that the electrolyte solution in which LiTFSA or LiFSA is used for the electrolyte reacts with and corrodes the positive electrode current collector in some cases when the positive electrode voltage is high. In order to inhibit such corrosion, several weight percent of LiPF₆ is preferably added to the electrolyte solution, in which case a passive film is formed on a surface of the positive electrode current collector and inhibits reaction between the electrolyte solution and the positive electrode current collector. Note that for maintenance of the cycle life at high temperatures the concentration of LiPF₆ is less than or equal to 10 wt %, preferably less than or equal to 5 wt %, and further preferably less than or equal to 3 wt % in order that the positive electrode substance layer is not dissolved.

### <Structure of Exterior Body>

Next, the exterior body 106 is described. As the exterior body 106, a film having a three-layer structure can be used, for example. In the three-layer structure, a highly flexible metal thin film of, for example, aluminum, stainless steel, copper, and nickel is provided over a film formed of a material such as polyethylene, polypropylene, polycarbonate, ionomer, and polyamide, and an insulating synthetic resin film of, for example, a polyamide-based resin or a polyester-based resin is provided as the outer surface of the exterior body over the metal thin film. With such a three-layer structure, permeation of an electrolyte solution and a gas can be blocked and an insulating property and resistance to the electrolyte solution can be provided. The exterior body is folded inside in two, or two exterior bodies are stacked with the inner surfaces facing each other, in which case application of heat melts the materials on the overlapping inner surfaces to cause fusion bonding between the two exterior bodies. In this manner, a sealing structure can be formed.

A portion where the sealing structure is formed by fusion bonding or the like of the exterior body is referred to as a sealing portion. In the case where the exterior body is folded inside in two, the sealing portion is formed in the place other than the fold, and a first region of the exterior body and a second region of the exterior body that overlaps with the first region are fusion-bonded, for example. In the case where two exterior bodies are stacked, the sealing portion is formed along the entire circumference by heat fusion bonding or the like.

When a flexible material is selected from materials of the members described in this embodiment and used, a flexible lithium-ion storage battery can be fabricated. Deformable devices are currently under active research and development. For such devices, flexible storage batteries are demanded.

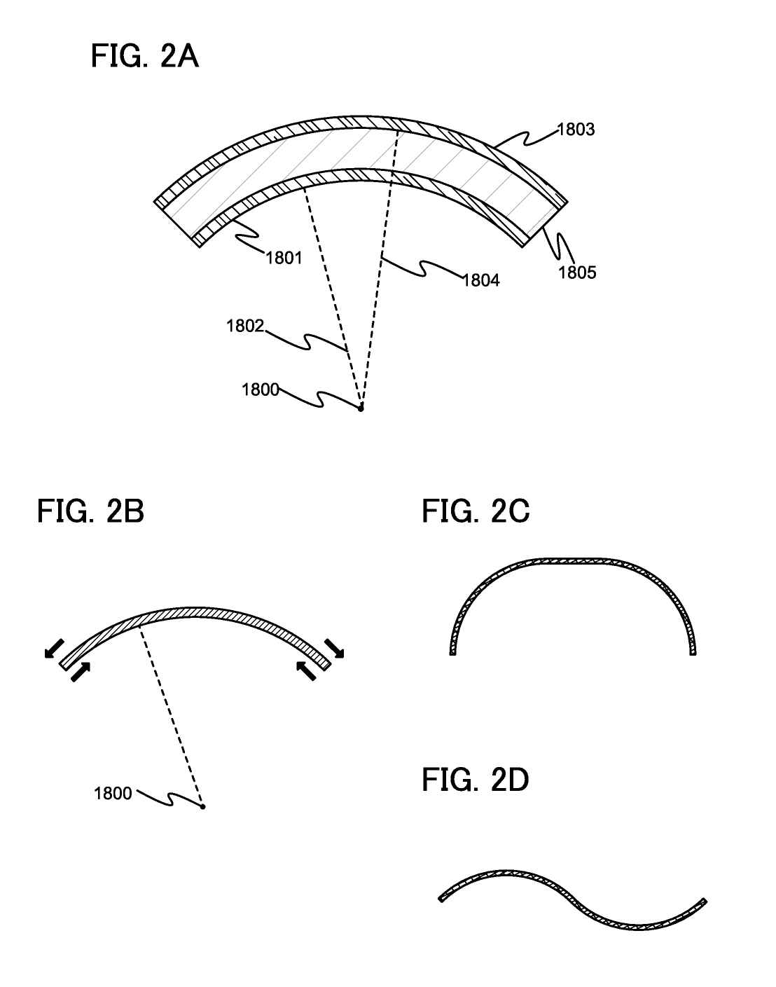

In the case of bending a storage battery in which a component 1805 including electrodes and an electrolyte solution is sandwiched between two films as exterior bodies, a radius 1802 of curvature of a film 1801 closer to a center 1800 of curvature of the storage battery is smaller than a radius 1804 of curvature of a film 1803 far from the center 1800 of curvature (FIG. 2A). When the storage battery is curved and has an arc-shaped cross section, compressive stress is applied to a surface of the film on the side closer to the center 1800 of curvature and tensile stress is applied to a surface of the film on the side farther from the center 1800 of curvature (FIG. 2B).

When a flexible lithium-ion storage battery is deformed, strong stress is applied to the exterior bodies. However, even with the compressive stress and tensile stress due to the deformation of the storage battery, the influence of a strain can be reduced by forming a pattern including projections or depressions on surfaces of the exterior bodies. For this reason, the storage battery can change its form in such a range that the exterior body on the side closer to the center of curvature has a curvature radius of 30 mm, preferably 10 mm.

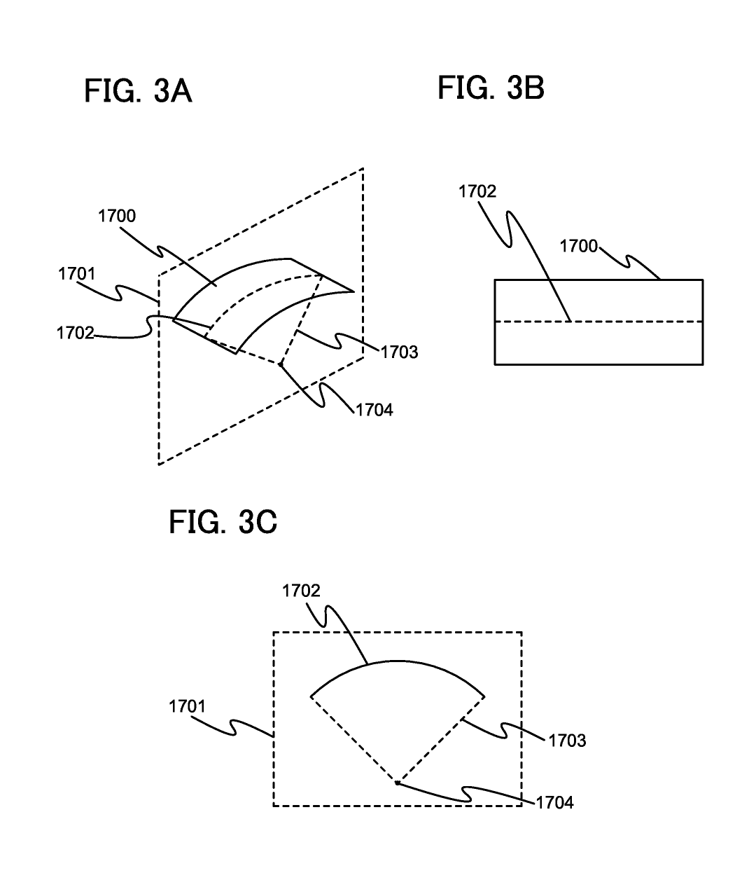

The radius of curvature of a surface is described with reference to FIGS. 3A to 3C. In FIG. 3A, on a plane 1701 along which a curved surface 1700 is cut, part of a curve 1702 forming the curved surface 1700 is approximate to an arc of a circle; the radius of the circle is referred to as a radius of curvature 1703 and the center of the circle is referred to as a center of curvature 1704. FIG. 3B is a top view of the curved surface 1700. FIG. 3C is a cross-sectional view of the curved surface 1700 taken along the plane 1701. When a curved surface is cut by a plane, the radius of curvature of a curve in a cross section differs depending on the angle between the curved surface and the plane or on the cut position, and the smallest radius of curvature is defined as the radius of curvature of a surface in this specification and the like.

Note that the cross-sectional shape of the storage battery is not limited to a simple arc shape, and the cross section can be partly arc-shaped; for example, a shape illustrated in FIG. 2C, a wavy shape illustrated in FIG. 2D, or an S shape can be used. When the curved surface of the storage battery has a shape with a plurality of centers of curvature, the storage battery can change its form in such a range that a curved surface with the smallest radius of curvature among radii of curvature with respect to the plurality of centers of curvature, which is a surface of the exterior body on the side closer to the center of curvature, has a curvature radius of 30 mm, preferably 10 mm.

In Embodiment 1, one embodiment of the present invention has been described. Other embodiments of the present invention are described in Embodiments 2 to 3. Note that one embodiment of the present invention is not limited thereto. In other words, various embodiments of the invention are described in this embodiment and the other embodiments, and one embodiment of the present invention is not limited to a particular embodiment. For example, although an example of use in a lithium-ion storage battery is described in this embodiment, one embodiment of the present invention is not limited thereto. Application to a variety of storage batteries such as a lead storage battery, a lithium-ion polymer storage battery, a nickel-hydrogen storage battery, a nickel-cadmium storage battery, a nickel-iron storage battery, a nickel-zinc storage battery, a silver oxide-zinc storage battery, a solid-state battery, and an air battery is also possible. Application to a variety of power storage devices such as a primary battery, a capacitor, and a lithium-ion capacitor is also possible. Depending on circumstances or conditions, one embodiment of the present invention is not necessarily applied to a lithium-ion storage battery, for example. The case where the electrolyte solution includes at least one of LiTFSA and LiFSA is described as one embodiment of the present invention; however, one embodiment of the present invention is not limited to this. Depending on circumstances or conditions, at least one of LiTFSA and LiFSA may be included in a part other than the electrolyte solution in one embodiment of the present invention. Depending on circumstances or conditions, the electrolyte solution may include a variety of materials in one embodiment of the present invention. Depending on circumstances or conditions, the electrolyte solution may include a material other than LiTFSA or LiFSA in one embodiment of the present invention, for example. Depending on circumstances or conditions, the electrolyte solution may include neither LiTFSA nor LiFSA in one embodiment of the present invention, for example.

This embodiment can be implemented in appropriate combination with any of the other embodiments and examples.

### Embodiment 2

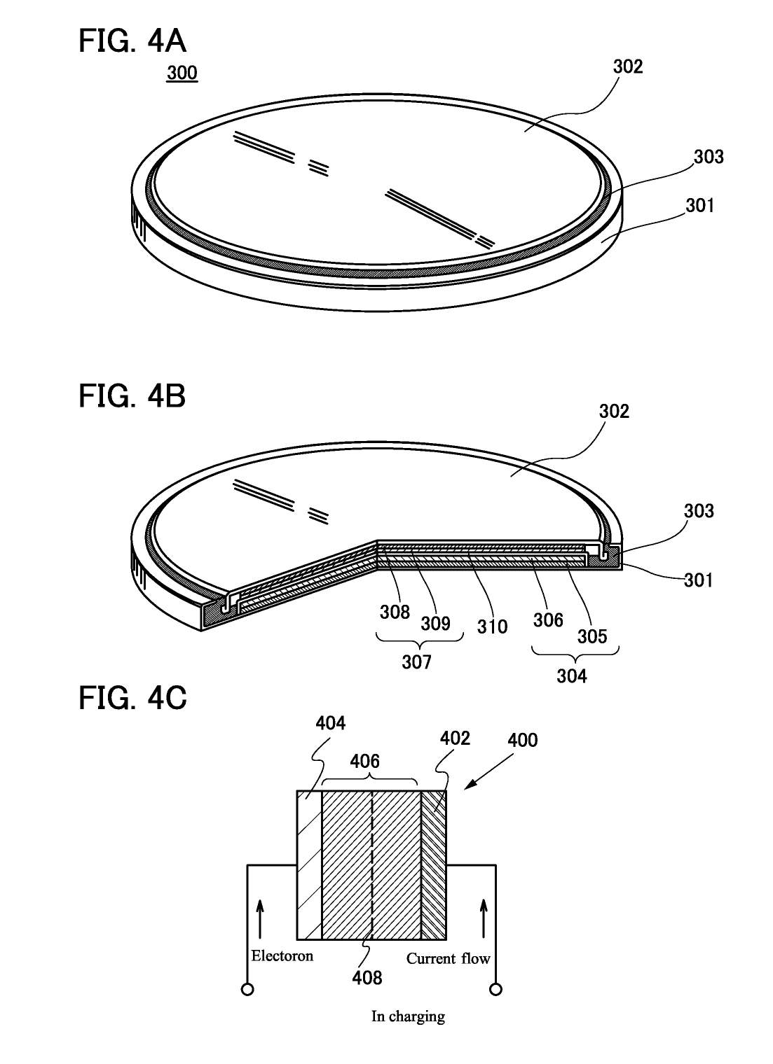

In this embodiment, structures of a storage battery of one embodiment of the present invention are described with reference to FIGS. 4A to 4C, FIGS. 5A and 5B, and FIGS. 6A and 6B.

### [Coin-Type Storage Battery]

FIG. 4A is an external view of a coin-type (single-layer flat type) storage battery, and FIG. 4B is a cross-sectional view thereof.

In a coin-type storage battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. The positive electrode active material layer 306 may further include a binder for increasing adhesion of positive electrode active materials, a conductive additive for increasing the conductivity of the positive electrode active material layer, and the like in addition to the positive electrode active materials.

A negative electrode 307 includes a negative electrode current collector 308 and a negative electrode active material layer 309 provided in contact with the negative electrode current collector 308. The negative electrode active material layer 309 may further include a binder for increasing adhesion of negative electrode active materials, a conductive additive for increasing the conductivity of the negative electrode active material layer, and the like in addition to the negative electrode active materials. A separator 310 and an electrolyte (not illustrated) are provided between the positive electrode active material layer 306 and the negative electrode active material layer 309.

The materials described in Embodiment 1 can be used for the components.

For the positive electrode can 301 and the negative electrode can 302, a metal having a corrosion-resistant property to an electrolyte solution, such as nickel, aluminum, or titanium, an alloy of such a metal, or an alloy of such a metal and another metal (e.g., stainless steel or the like) can be used. Alternatively, the positive electrode can 301 and the negative electrode can 302 are preferably covered with nickel, aluminum, or the like in order to inhibit corrosion due to the electrolyte solution. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 4B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 interposed therebetween. In such a manner, the coin-type storage battery 300 can be fabricated.

Here, a current flow in charging a storage battery will be described with reference to FIG. 4C. When a storage battery using lithium is regarded as a closed circuit, lithium ions transfer and a current flows in the same direction. Note that in the storage battery using lithium, an anode and a cathode change places in charge and discharge, and an oxidation reaction and a reduction reaction occur on the corresponding sides; hence, an electrode with a high redox potential is called a positive electrode and an electrode with a low redox potential is called a negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charging current is supplied. The use of the terms “anode” and “cathode” related to an oxidation reaction and a reduction reaction might cause confusion because the anode and the cathode change places at the time of charging and discharging. Thus, the terms “anode” and “cathode” are not used in this specification. If the term “anode” or “cathode” is used, it should be mentioned that the anode or the cathode is which of the one at the time of charging or the one at the time of discharging and corresponds to which of a positive electrode or a negative electrode.

A storage battery 400 in FIG. 4C includes a positive electrode 402, a negative electrode 404, an electrolyte solution 406, and a separator 408. Two terminals connected to the positive electrode 402 and the negative electrode 404 are connected to a charger, and a storage battery 400 is charged. As the charge of the storage battery 400 proceeds, a potential difference between electrodes increases. The positive direction in FIG. 4C is the direction in which a current flows from one terminal outside the storage battery 400 to a positive electrode 402, flows from the positive electrode 402 to a negative electrode 404 in the storage battery 400, and flows from the negative electrode 404 to the other terminal outside the storage battery 400. In other words, a current flows in the direction of a flow of a charging current.

### [Cylindrical Storage Battery]

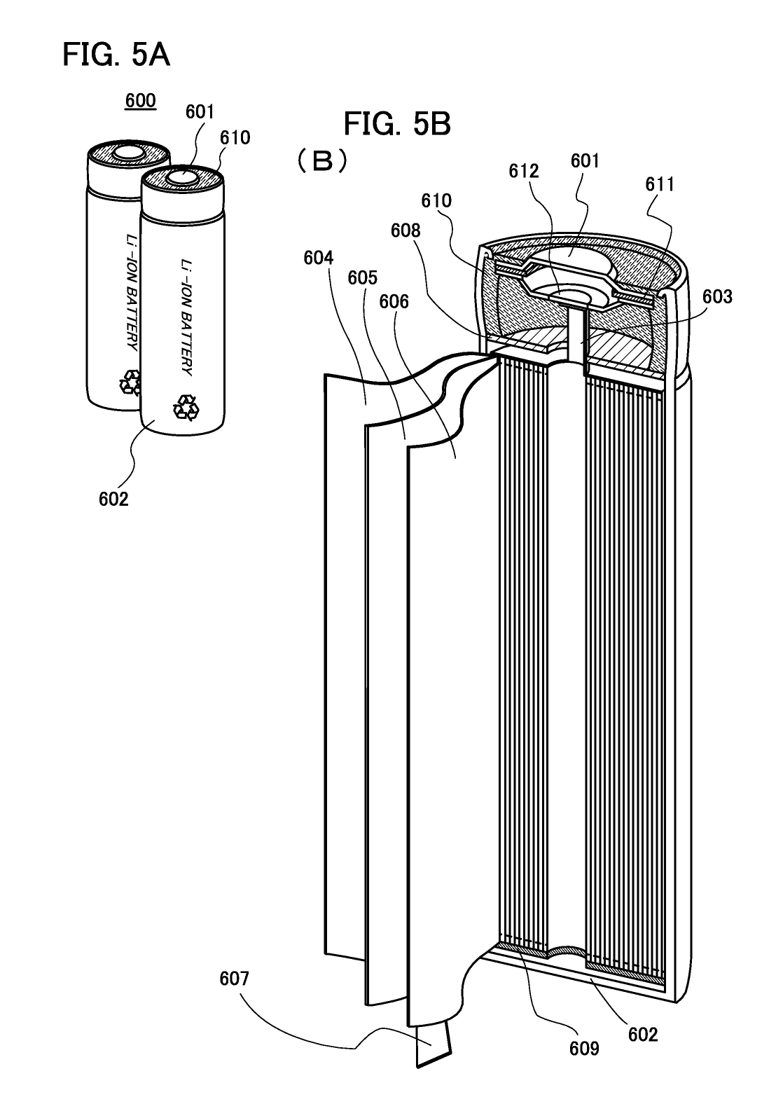

Next, an example of a cylindrical storage battery will be described with reference to FIGS. 5A and 5B. As illustrated in FIG. 5A, a cylindrical storage battery 600 includes a positive electrode cap (battery cap) 601 on the top surface and a battery can (outer can) 602 on the side surface and bottom surface. The positive electrode cap 601 and the battery can 602 are insulated from each other by a gasket (insulating gasket) 610.

FIG. 5B is a diagram schematically illustrating a cross section of the cylindrical storage battery. Inside the battery can 602 having a hollow cylindrical shape, a battery element in which a strip-like positive electrode 604 and a strip-like negative electrode 606 are wound with a stripe-like separator 605 interposed therebetween is provided. Although not illustrated, the battery element is wound around a center pin. One end of the battery can 602 is close and the other end thereof is open. For the battery can 602, a metal having a corrosion-resistant property to an electrolyte solution, such as nickel, aluminum, or titanium, an alloy of such a metal, or an alloy of such a metal and another metal (e.g., stainless steel or the like) can be used. Alternatively, the battery can 602 is preferably covered with nickel, aluminum, or the like in order to inhibit corrosion due to the electrolyte solution. Inside the battery can 602, the battery element in which the positive electrode, the negative electrode, and the separator are wound is provided between a pair of insulating plates 608 and 609 which face each other. Furthermore, a nonaqueous electrolyte solution (not illustrated) is injected inside the battery can 602 provided with the battery element. As the nonaqueous electrolyte solution, a nonaqueous electrolyte solution that is similar to that of the coin-type storage battery can be used.

Although the positive electrode 604 and the negative electrode 606 can be formed in a manner similar to that of the positive electrode and the negative electrode of the coin-type storage battery described above, the difference lies in that, since the positive electrode and the negative electrode of the cylindrical storage battery are wound, active materials are formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as the temperature rises, limits the amount of current by increasing the resistance, in order to inhibit abnormal heat generation. Note that barium titanate (BaTiO₃)-based semiconductor ceramic can be used for the PTC element.

### [Laminated Storage Battery]

Next, an example of a laminated storage battery will be described with reference to FIG. 6A. When a flexible laminated storage battery is used in an electronic device at least part of which is flexible, the storage battery can be bent as the electronic device is bent.

A laminated storage battery 500 illustrated in FIG. 6A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The electrolyte solution 508 is included in the exterior body 509. The electrolyte solution described in Embodiment 1 can be used for the electrolyte solution 508.

In the laminated storage battery 500 illustrated in FIG. 6A, the positive electrode current collector 501 and the negative electrode current collector 504 also serve as terminals for an electrical contact with an external portion. For this reason, each of the positive electrode current collector 501 and the negative electrode current collector 504 may be arranged so that part of the positive electrode current collector 501 and part of the negative electrode current collector 504 are exposed to the outside of the exterior body 509. Alternatively, a lead electrode and the positive electrode current collector 501 or the negative electrode current collector 504 may be bonded to each other by ultrasonic welding, and instead of the positive electrode current collector 501 and the negative electrode current collector 504, the lead electrode may be exposed to the outside of the exterior body 509.

As the exterior body 509 in the laminated storage battery 500, for example, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used.

FIG. 6B illustrates an example of a cross-sectional structure of the laminated storage battery 500. FIG. 6A illustrates an example of including only two current collectors for simplicity, and the actual battery includes a plurality of electrode layers.

The example in FIG. 6B includes 16 electrode layers. The laminated storage battery 500 has flexibility even though including 16 electrode layers. In FIG. 6B, 8 negative electrode current collectors 504 and 8 positive electrode current collectors 501 are included. Note that FIG. 6B illustrates a cross section of the lead portion of the negative electrode, and 8 negative electrode current collectors 504 are bonded to each other by ultrasonic welding. It is needless to say that the number of electrode layers is not limited to 16, and may be more than 16 or less than 16. In the case of using a large number of electrode layers, the storage battery can have high capacity. In contrast, in the case of using a small number of electrode layers, the storage battery can have a small thickness and high flexibility.

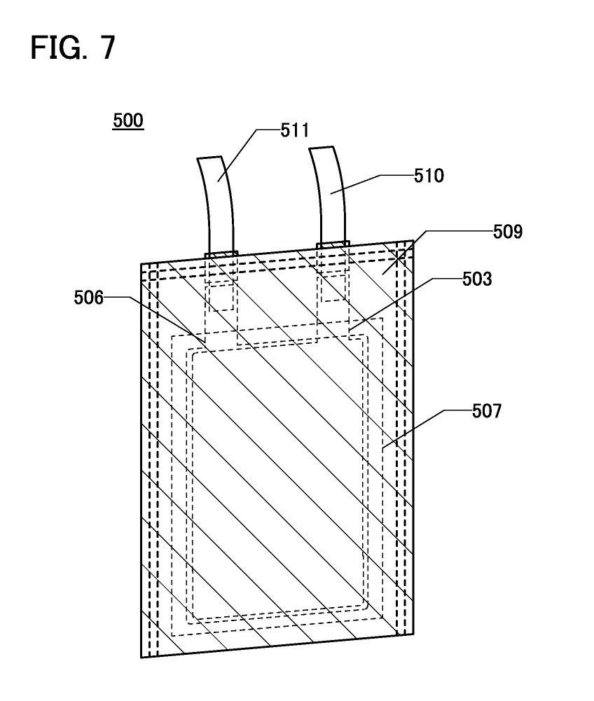

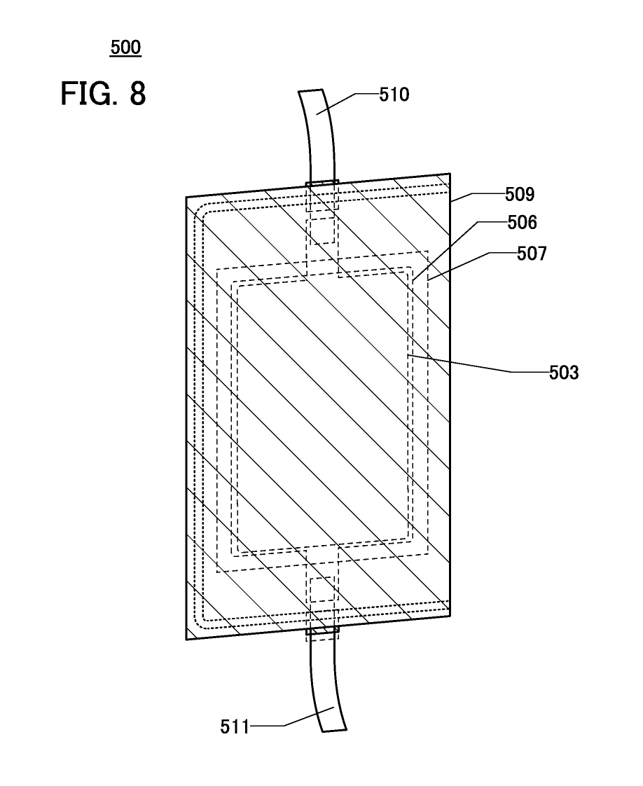

FIGS. 7 and 8 each illustrate an example of the external view of the laminated storage battery 500. In FIGS. 7 and 8, the positive electrode 503, the negative electrode 506, the separator 507, the exterior body 509, a positive electrode lead electrode 510, and a negative electrode lead electrode 511 are included.

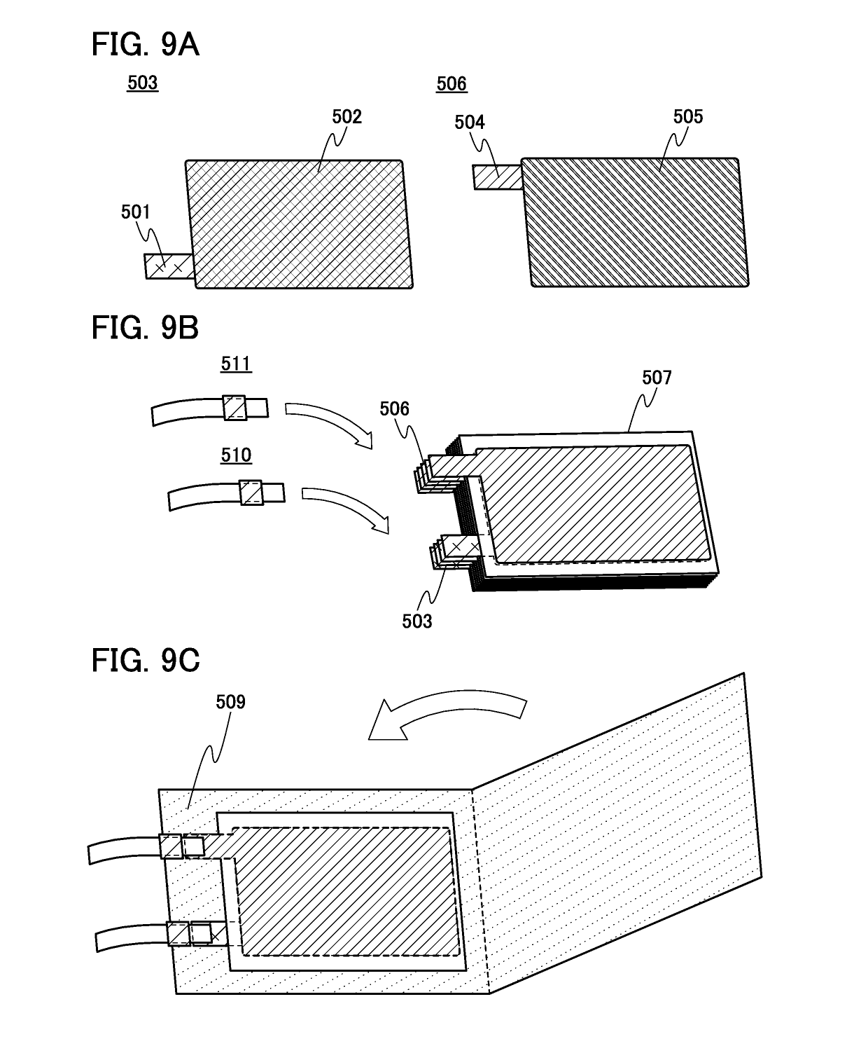

FIG. 9A illustrates the external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter also referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and shapes of the tab regions included in the positive electrode and negative electrode are not limited to those illustrated in FIG. 9A.

### [Method for Fabricating Laminated Storage Battery]

Here, an example of a method for fabricating the laminated storage battery whose external view is illustrated in FIG. 7 will be described with reference to FIGS. 9B and 9C.

First, the negative electrode 506, the separator 507, and the positive electrode 503 are stacked. FIG. 9B illustrates a stack including the negative electrode 506, the separator 507, and the positive electrode 503. The battery described here as an example includes 5 negative electrodes and 4 positive electrodes. Next, the tab regions of the positive electrodes 503 are bonded to each other, and the tab region of the positive electrode of the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode of the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a dashed line as illustrated in FIG. 9C. Then, the outer edge of the exterior body 509 is bonded. The bonding can be performed by thermocompression, for example. At this time, a part (or one side) of the exterior body 509 is left unbonded (to provide an inlet) so that the electrolyte solution 508 can be introduced later.

Next, the electrolyte solution 508 is introduced into the exterior body 509 from the inlet of the exterior body 509. The electrolyte solution 508 is preferably introduced in a reduced pressure atmosphere or in an inert gas atmosphere. Lastly, the inlet is bonded. In the above manner, the laminated storage battery 500 can be fabricated.

Note that, in this embodiment, the coin-type storage battery, the laminated storage battery, and the cylindrical storage battery are given as examples of the storage battery; however, any of storage batteries with a variety of shapes, such as a sealed storage battery and a square-type storage battery, can be used. Furthermore, a structure in which a plurality of positive electrodes, a plurality of negative electrodes, and a plurality of separators are stacked or wound may be employed.

For each of the positive electrode active material layers and electrolyte solutions of the storage batteries 300, 500, and 600, which are described in this embodiment, the positive electrode active material layer and electrolyte solution of one embodiment of the present invention can be used. Thus, the cycle life of the storage batteries 300, 500, and 600 can be increased.

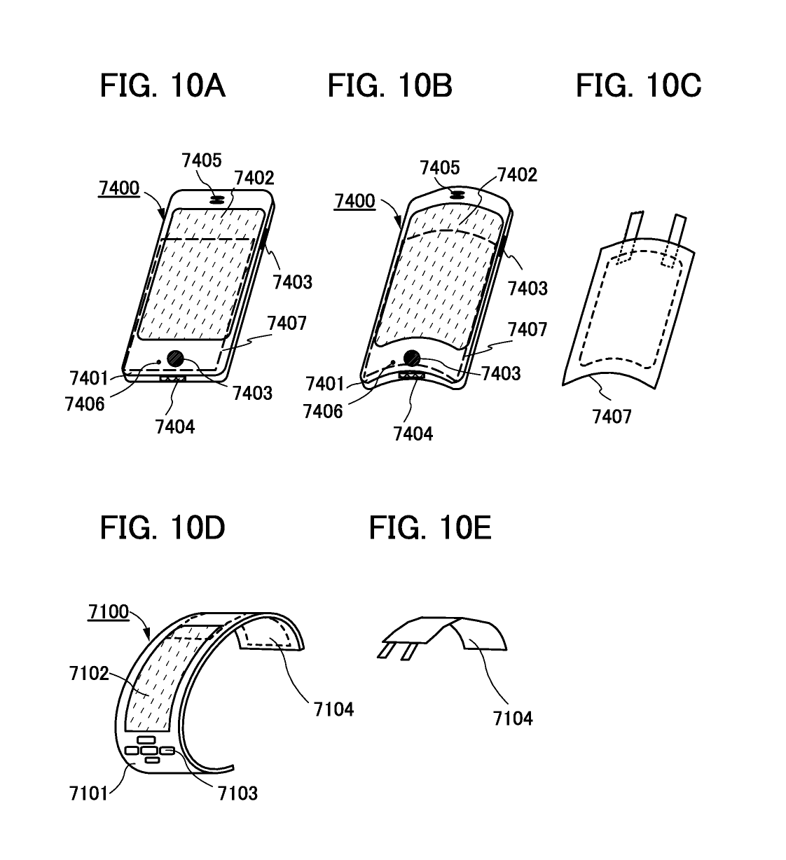

FIGS. 10A to 10E illustrate examples of electronic devices including flexible laminated storage batteries. Examples of electronic devices each including a flexible power storage device include television devices (also referred to as televisions or television receivers), monitors of computers or the like, cameras such as digital cameras and digital video cameras, digital photo frames, mobile phones (also referred to as cellular phones or mobile phone devices), portable game machines, portable information terminals, audio reproducing devices, and large game machines such as pachinko machines.

In addition, a flexible power storage device can be incorporated along a curved inside/outside wall surface of a house or a building or a curved interior/exterior surface of an automobile.

FIG. 10A illustrates an example of a mobile phone. A mobile phone 7400 is provided with a display portion 7402 incorporated in a housing 7401, an operation button 7403, an external connection port 7404, a speaker 7405, a microphone 7406, and the like. Note that the mobile phone 7400 includes a power storage device 7407.

FIG. 10B illustrates the mobile phone 7400 that is bent. When the whole mobile phone 7400 is bent by the external force, the power storage device 7407 included in the mobile phone 7400 is also bent. FIG. 10C illustrates the bent power storage device 7407. The power storage device 7407 is a laminated storage battery.

FIG. 10D illustrates an example of a bangle display device. A portable display device 7100 includes a housing 7101, a display portion 7102, an operation button 7103, and a power storage device 7104. FIG. 10E illustrates the bent power storage device 7104.

### [Structural Example of Power Storage Device]

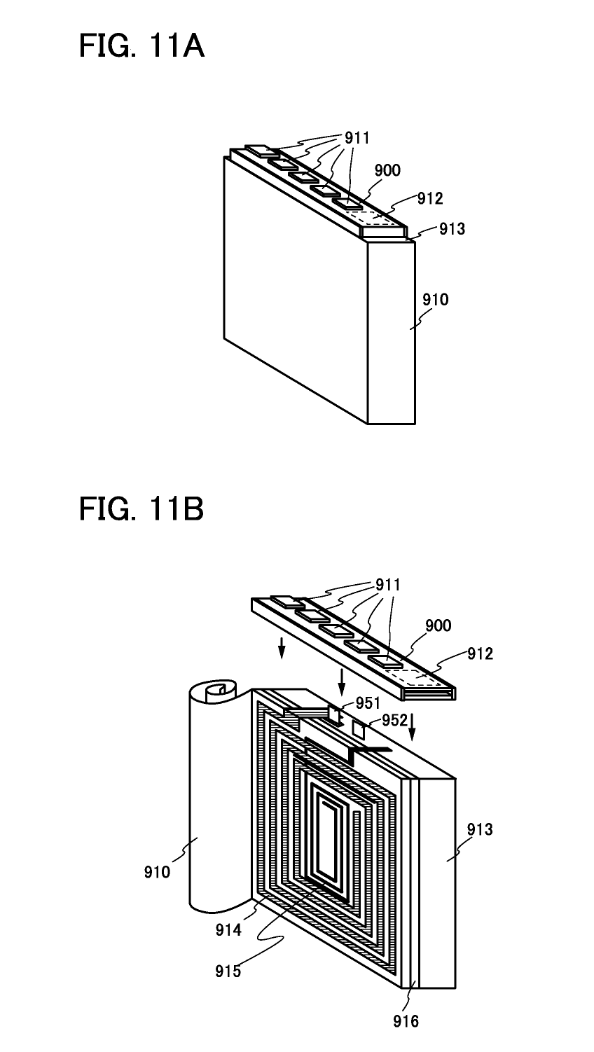

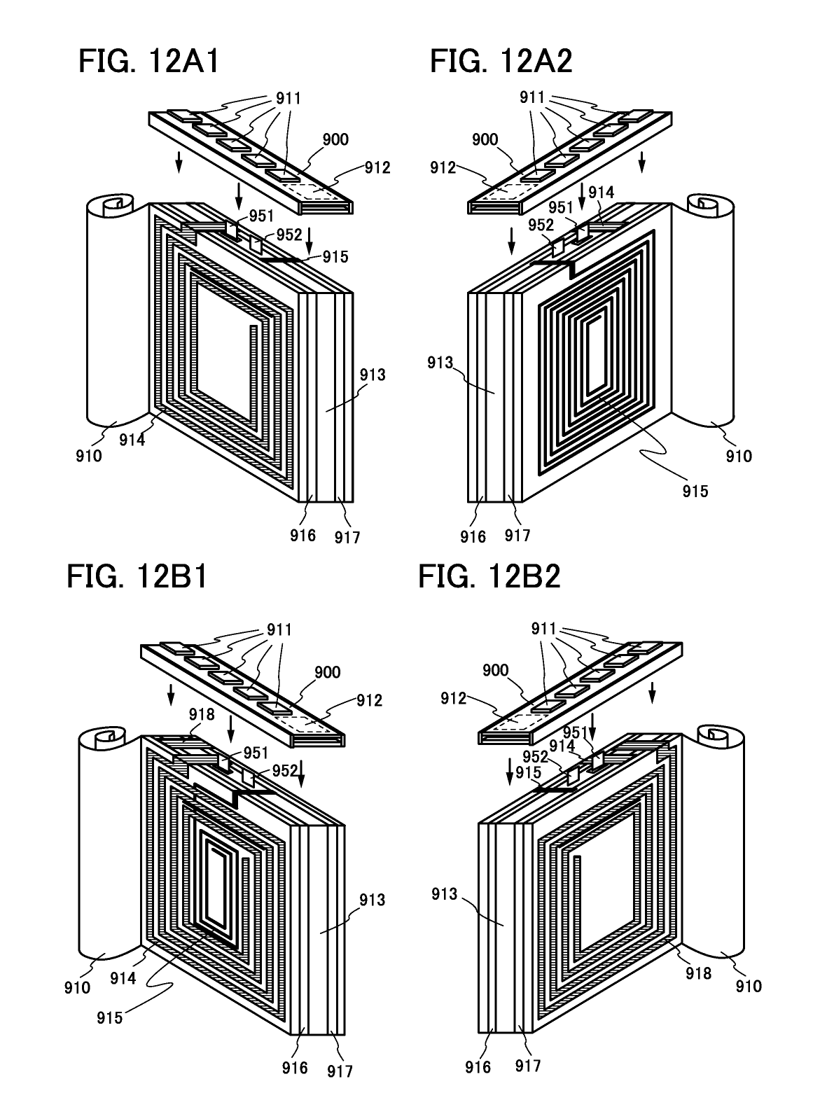

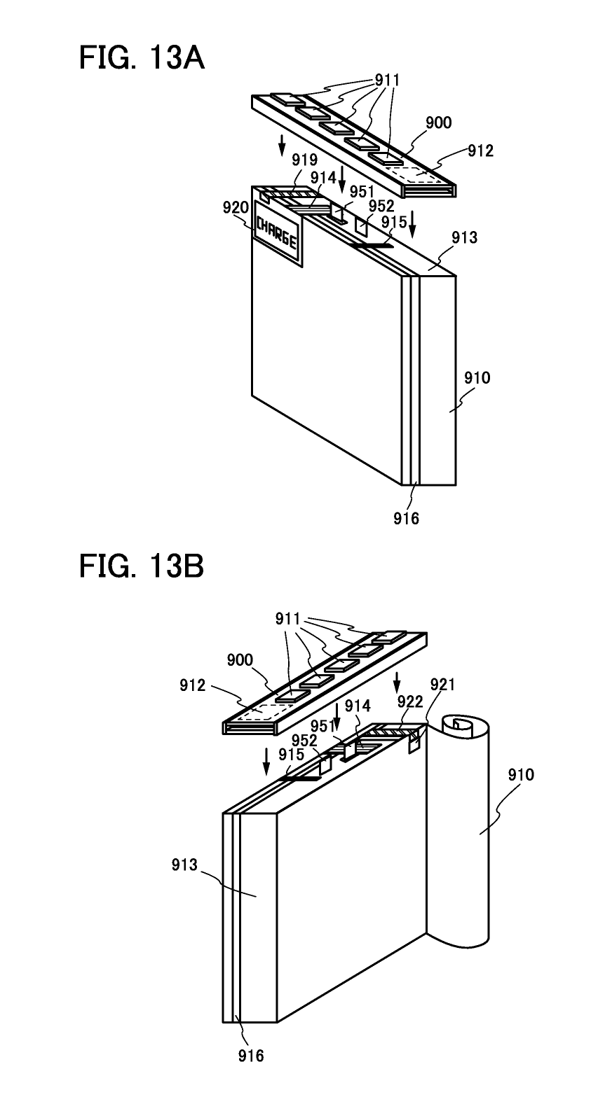

Structural examples of power storage devices will be described with reference to FIGS. 11A and 11B, FIGS. 12A1, 12A2, 12B1, and 12B2, FIGS. 13A and 13B, FIGS. 14A and 14B, and FIG. 15.

FIGS. 11A and 11B are external views of a power storage device. The power storage device includes a circuit board 900 and a storage battery 913. A label 910 is attached to the storage battery 913. As shown in FIG. 11B, the power storage device further includes a terminal 951, a terminal 952, an antenna 914, and an antenna 915.

The circuit board 900 includes terminals 911 and a circuit 912. The terminals 911 are connected to the terminals 951 and 952, the antennas 914 and 915, and the circuit 912. Note that a plurality of terminals 911 serving as a control signal input terminal, a power supply terminal, and the like may be provided.

The circuit 912 may be provided on the rear surface of the circuit board 900. The shape of each of the antennas 914 and 915 is not limited to a coil shape and may be a linear shape or a plate shape. Furthermore, a planar antenna, an aperture antenna, a traveling-wave antenna, an EH antenna, a magnetic-field antenna, a dielectric antenna, or the like may be used. Alternatively, the antenna 914 or the antenna 915 may be a flat-plate conductor. The flat-plate conductor can serve as one of conductors for electric field coupling. That is, the antenna 914 or the antenna 915 can serve as one of two conductors of a capacitor. Thus, electric power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage device includes a layer 916 between the storage battery 913 and the antennas 914 and 915. The layer 916 may have a function of inhibiting an adverse effect on an electromagnetic field by the storage battery 913. As the layer 916, for example, a magnetic body can be used.

Note that the structure of the power storage device is not limited to that shown in FIGS. 11A and 11B.

For example, as shown in FIGS. 12A1 and 12A2, two opposite surfaces of the storage battery 913 in FIGS. 11A and 11B may be provided with respective antennas. FIG. 12A1 is an external view showing one side of the opposite surfaces, and FIG. 12A2 is an external view showing the other side of the opposite surfaces. For portions similar to those in FIGS. 11A and 11B, a description of the power storage device illustrated in FIGS. 11A and 11B can be referred to as appropriate.

As illustrated in FIG. 12A1, the antenna 914 is provided on one of the opposite surfaces of the storage battery 913 with the layer 916 interposed therebetween, and as illustrated in FIG. 12A2, the antenna 915 is provided on the other of the opposite surfaces of the storage battery 913 with a layer 917 interposed therebetween. The layer 917 may have a function of inhibiting an adverse effect on an electromagnetic field by the storage battery 913, for example. As the layer 917, for example, a magnetic body can be used.

With the above structure, both of the antennas 914 and 915 can be increased in size.

Alternatively, as illustrated in FIGS. 12B1 and 12B2, two opposite surfaces of the storage battery 913 in FIGS. 11A and 11B may be provided with different types of antennas. FIG. 12B1 is an external view showing one side of the opposite surfaces, and FIG. 12B2 is an external view showing the other side of the opposite surfaces. For portions similar to those in FIGS. 11A and 11B, a description of the power storage device illustrated in FIGS. 11A and 11B can be referred to as appropriate.

As illustrated in FIG. 12B1, the antennas 914 and 915 are provided on one of the opposite surfaces of the storage battery 913 with the layer 916 interposed therebetween, and as illustrated in FIG. 12B2, an antenna 918 is provided on the other of the opposite surfaces of the storage battery 913 with the layer 917 interposed therebetween. The antenna 918 has a function of communicating data with an external device, for example. An antenna with a shape that can be applied to the antennas 914 and 915, for example, can be used as the antenna 918. As a system for communication using the antenna 918 between the power storage device and another device, a response method that can be used between the power storage device and another device, such as NFC, can be employed.

Alternatively, as illustrated in FIG. 13A, the storage battery 913 in FIGS. 11A and 11B may be provided with a display device 920. The display device 920 is electrically connected to the terminal 911 via a terminal 919. It is possible that the label 910 is not provided in a portion where the display device 920 is provided. For portions similar to those in FIGS. 11A and 11B, a description of the power storage device illustrated in FIGS. 11A and 11B can be referred to as appropriate.

The display device 920 can display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 13B, the storage battery 913 illustrated in FIGS. 11A and 11B may be provided with a sensor 921. The sensor 921 is electrically connected to the terminal 911 via a terminal 922. For portions similar to those in FIGS. 11A and 11B, a description of the power storage device illustrated in FIGS. 11A and 11B can be referred to as appropriate.

The sensor 921 has a function of measuring, for example, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays. With the sensor 921, for example, data on an environment (e.g., temperature) where the power storage device is placed can be determined and stored in a memory inside the circuit 912.

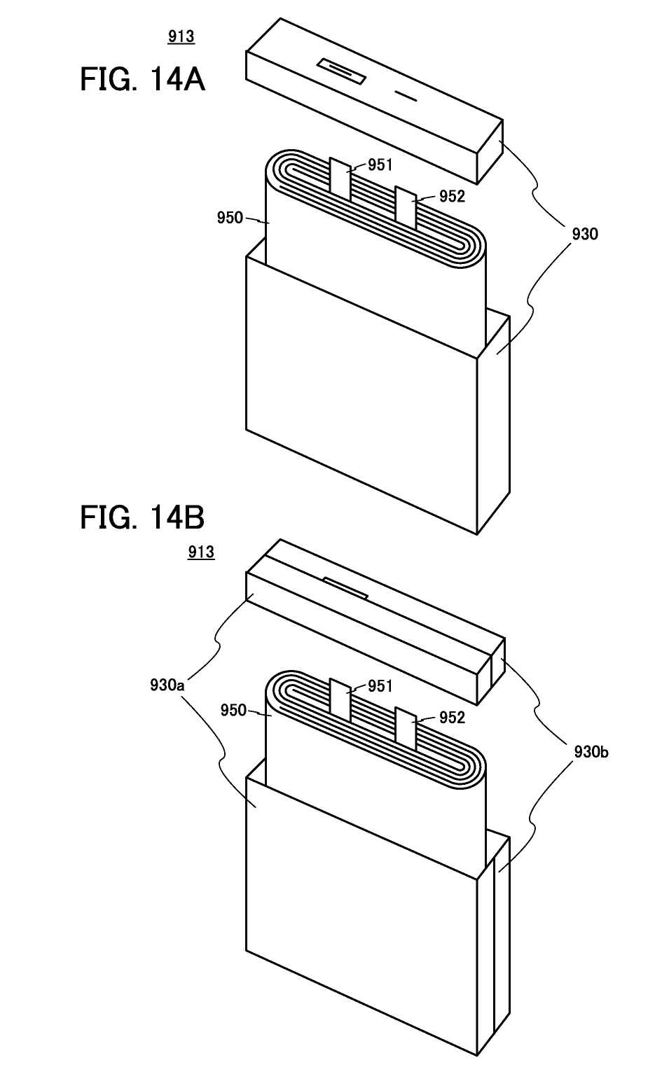

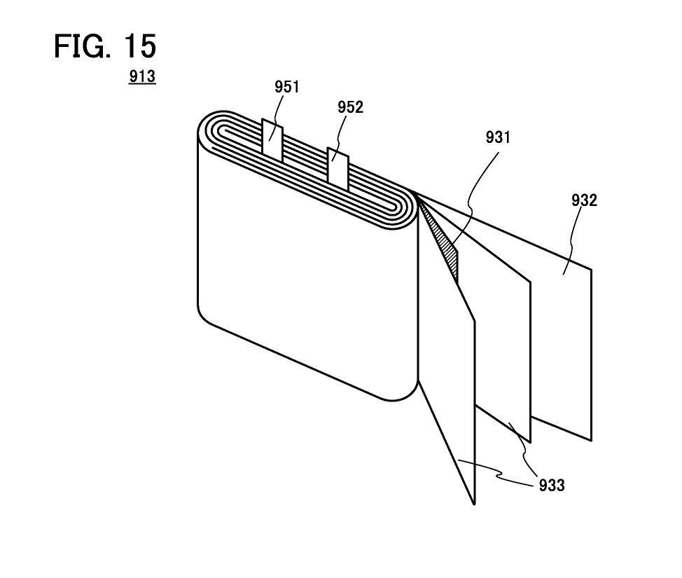

Furthermore, structural examples of the storage battery 913 will be described with reference to FIGS. 14A and 14B and FIG. 15.

The storage battery 913 illustrated in FIG. 14A includes a wound body 950 provided with the terminals 951 and 952 inside a housing 930. The wound body 950 is soaked in an electrolyte solution inside the housing 930. The terminal 952 is in contact with the housing 930. An insulator or the like inhibits contact between the terminal 951 and the housing 930. Note that in FIG. 14A, the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 14B, the housing 930 in FIG. 14A may be formed using a plurality of materials. For example, in the storage battery 913 in FIG. 14B, a housing 930a and a housing 930b are bonded to each other and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the storage battery 913 can be inhibited. When an electric field is not significantly blocked by the housing 930a, an antenna such as the antennas 914 and 915 may be provided inside the housing 930a. For the housing 930b, a metal material can be used, for example.

FIG. 15 illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks of the negative electrode 931, the positive electrode 932, and the separator 933 may be stacked.

The negative electrode 931 is connected to the terminal 911 in FIGS. 11A and 11B via one of the terminals 951 and 952. The positive electrode 932 is connected to the terminal 911 in FIGS. 11A and 11B via the other of the terminals 951 and 952.

### [Examples of Electrical Devices: Vehicles]

Next, examples where a storage battery is used in a vehicle will be described. The use of storage batteries in vehicles enables production of next-generation clean energy vehicles such as hybrid electric vehicles (HEV), electric vehicles (EV), and plug-in hybrid electric vehicles (PHEV).

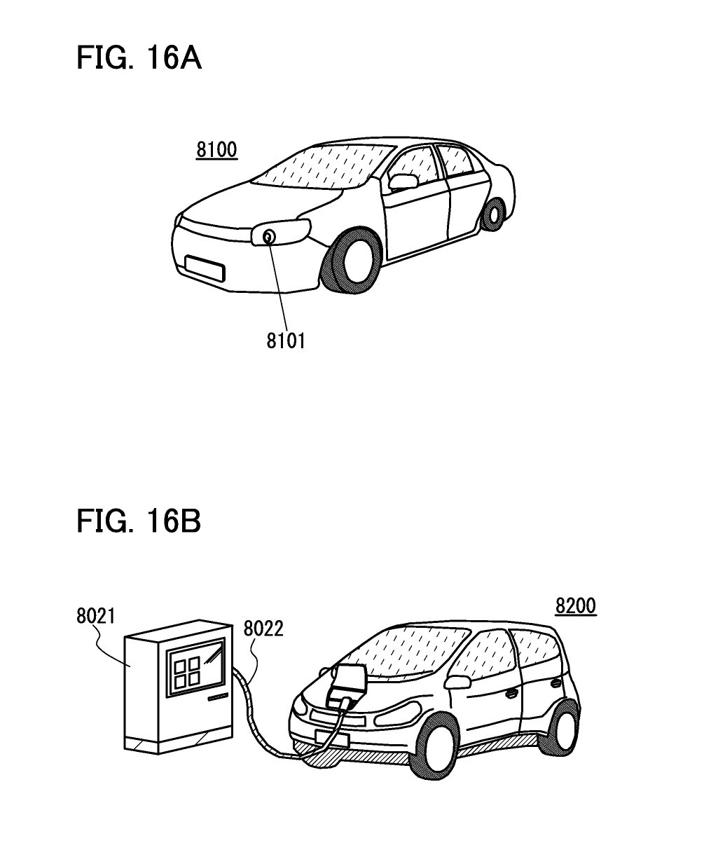

FIGS. 16A and 16B each illustrate an example of a vehicle using one embodiment of the present invention. An automobile 8100 illustrated in FIG. 16A is an electric vehicle that runs on the power of an electric motor. Alternatively, the automobile 8100 is a hybrid electric vehicle capable of driving appropriately using either the electric motor or the engine. One embodiment of the present invention can provide a vehicle which can be repeatedly charged and discharged. The automobile 8100 includes the power storage device. The power storage device is used not only for driving the electric motor, but also for supplying electric power to a light-emitting device such as a headlight 8101 or an interior light (not illustrated).

The power storage device can also supply electric power to a display device of a speedometer, a tachometer, or the like included in the automobile 8100. Furthermore, the power storage device can supply electric power to a semiconductor device included in the automobile 8100, such as a navigation system.

FIG. 16B illustrates an automobile 8200 including the power storage device. The automobile 8200 can be charged when the power storage device is supplied with electric power through external charging equipment by a plug-in system, a contactless power feeding system, or the like. In FIG. 16B, the power storage device included in the automobile 8200 is charged with the use of a ground-based charging apparatus 8021 through a cable 8022. In charging, a given method such as CHAdeMO (registered trademark) or Combined Charging System may be employed as a charging method, the standard of a connector, or the like as appropriate. The charging apparatus 8021 may be a charging station provided in a commerce facility or a power source in a house. For example, with the use of a plug-in technique, the power storage device included in the automobile 8200 can be charged by being supplied with electric power from outside. The charging can be performed by converting AC electric power into DC electric power through a converter such as an AC-DC converter.

Furthermore, although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the electric vehicle is stopped but also when driven. In addition, the contactless power feeding system may be utilized to perform transmission and reception of electric power between vehicles. Furthermore, a solar cell may be provided in the exterior of the automobile to charge the power storage device when the automobile stops or moves. To supply electric power in such a contactless manner, an electromagnetic induction method or a magnetic resonance method can be used.

According to one embodiment of the present invention, the power storage device can have improved cycle life and reliability. Furthermore, according to one embodiment of the present invention, the power storage device itself can be made more compact and lightweight as a result of improved characteristics of the power storage device. The compact and lightweight power storage device contributes to a reduction in the weight of a vehicle, and thus increases the mileage. Furthermore, the power storage device included in the vehicle can be used as a power source for supplying electric power to products other than the vehicle. In such a case, the use of a commercial power source can be avoided at peak time of electric power demand.

This embodiment can be implemented in appropriate combination with any of the other embodiments and examples.

Note that in the case where at least one specific example is described in a diagram or a text described in one embodiment in this specification and the like, it will be readily appreciated by those skilled in the art that a broader concept of the specific example can be derived. Therefore, in the diagram or the text described in one embodiment, in the case where at least one specific example is described, a broader concept of the specific example is disclosed as one embodiment of the invention, and one embodiment of the invention can be constituted. The embodiment of the present invention is clear.

Note that in this specification and the like, a content described in at least a diagram (which may be part of the diagram) is disclosed as one embodiment of the invention, and one embodiment of the invention can be constituted. Therefore, when a certain content is described in a diagram, the content is disclosed as one embodiment of the invention even when the content is not described with a text, and one embodiment of the invention can be constituted. In a similar manner, part of a diagram, which is taken out from the diagram, is disclosed as one embodiment of the invention, and one embodiment of the invention can be constituted. The embodiment of the present invention is clear.

### Embodiment 3

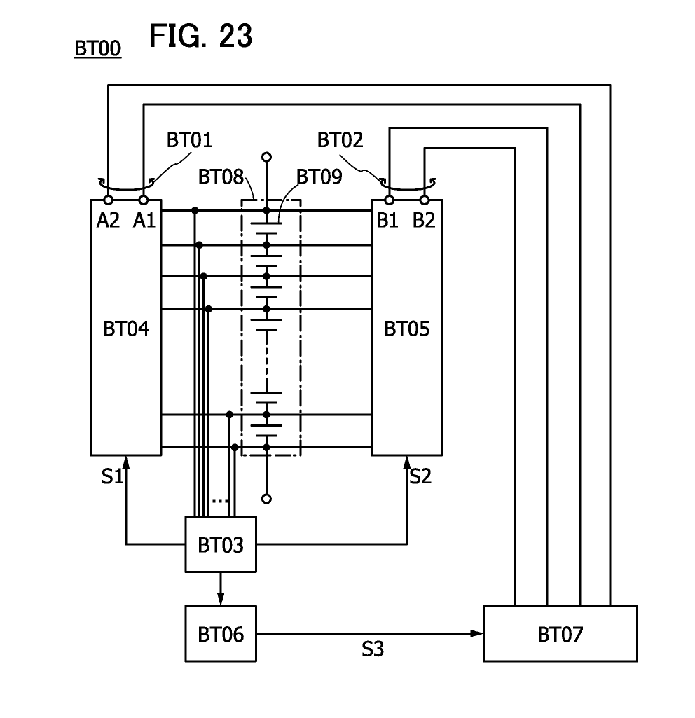

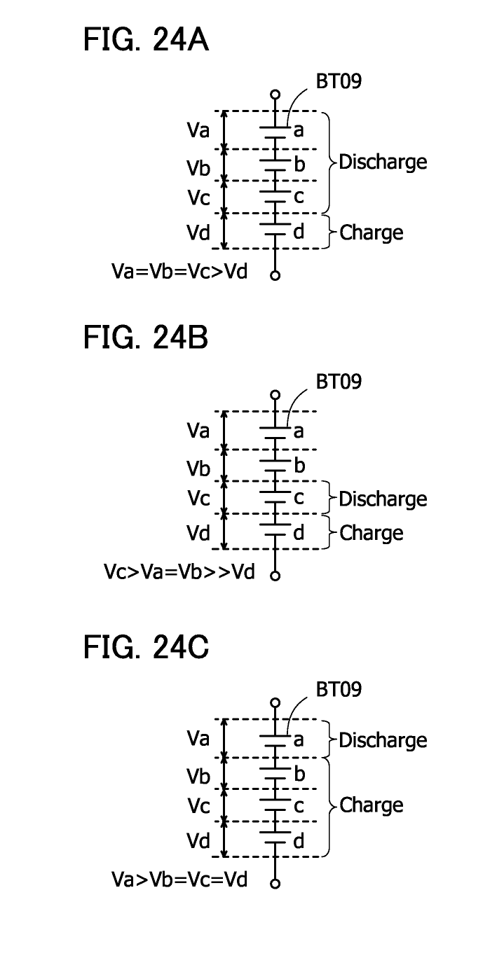

A battery management unit (BMU) which can be combined with a battery cell including the materials described in the above embodiment and a transistor suitable for a circuit included in the battery management unit are described with reference to FIG. 23, FIGS. 24A to 24C, FIG. 25, FIG. 26, FIGS. 27A to 27C, FIG. 28, and FIG. 29. In this embodiment, a battery management unit of a power storage device including battery cells that are connected in series is particularly described.

When a plurality of battery cells connected in series are charged and discharged repeatedly, each battery cell has different capacity (output voltage) from one another due to the variation in performance among the battery cells. A discharge capacity of all of the battery cells connected in series depends on a battery cell with low capacity. The variation in capacities reduces the capacity of the battery cells at the time of discharging. Charging based on a battery cell with low capacity may cause insufficient charging. Charging based on a battery cell with high capacity may cause overcharge.

Thus, the battery management unit of the power storage device including battery cells connected in series has a function of reducing variation in capacities among the battery cells which causes insufficient charging or overcharge. Although circuit structures for reducing variation in capacities among the battery cells include a resistive type, a capacitor type, and an inductor type, a circuit structure which can reduce variation in capacities among the battery cells using transistors with a low off-state current is explained here as an example.

A transistor including an oxide semiconductor in its channel formation region (an OS transistor) is preferably used as the transistor with a low off-state current. When an OS transistor with a low off-state current is used in the circuit of the battery management unit of the power storage device, the amount of electric charge leaking from a battery can be reduced, and reduction in capacity over time can be suppressed.

As the oxide semiconductor used in the channel formation region, an In-M-Zn oxide (M is Ga, Sn, Y, Zr, La, Ce, or Nd) is used. In the case where the atomic ratio of the metal elements of a target for forming an oxide semiconductor film is In:M:Zn=x₁:y₁:z₁, x₁/y₁ is preferably greater than or equal to ⅓ and less than or equal to 6, further preferably greater than or equal to 1 and less than or equal to 6, and z₁/y₁ is preferably greater than or equal to ⅓ and less than or equal to 6, further preferably greater than or equal to 1 and less than or equal to 6. Note that when z₁/y₁ is greater than or equal to 1 and less than or equal to 6, a CAAC-OS film as the oxide semiconductor film is easily formed.

Here, the details of the CAAC-OS film are described.

The CAAC-OS film is one of oxide semiconductor films having a plurality of c-axis aligned crystal parts.

In a combined analysis image (also referred to as a high-resolution TEM image) of a bright-field image and a diffraction pattern of a CAAC-OS film, which is obtained using a transmission electron microscope (TEM), a plurality of crystal parts can be observed. However, in the high-resolution TEM image, a boundary between crystal parts, that is, a grain boundary is not clearly observed. Thus, in the CAAC-OS film, a reduction in electron mobility due to the grain boundary is less likely to occur.

According to the high-resolution cross-sectional TEM image of the CAAC-OS film observed in a direction substantially parallel to a sample surface, metal atoms are arranged in a layered manner in the crystal parts. Each metal atom layer has a morphology reflecting unevenness of a surface over which the CAAC-OS film is formed (hereinafter, a surface over which the CAAC-OS film is formed is referred to as a formation surface) or of a top surface of the CAAC-OS film, and is arranged parallel to the formation surface or the top surface of the CAAC-OS film.

On the other hand, according to the high-resolution planar TEM image of the CAAC-OS film observed in a direction substantially perpendicular to the sample surface, metal atoms are arranged in a triangular or hexagonal configuration in the crystal parts. However, there is no regularity of arrangement of metal atoms between different crystal parts.

A CAAC-OS film is subjected to structural analysis with an X-ray diffraction (XRD) apparatus. For example, when the CAAC-OS film including an InGaZnO₄ crystal is analyzed by an out-of-plane method, a peak appears frequently when the diffraction angle (2θ) is around 31°. This peak is derived from the (009) plane of the InGaZnO₄ crystal, which indicates that crystals in the CAAC-OS film have c-axis alignment, and that the c-axes are aligned in a direction substantially perpendicular to the formation surface or the top surface of the CAAC-OS film.

Note that when the CAAC-OS film with an InGaZnO₄ crystal is analyzed by an out-of-plane method, a peak of 2θ may also be observed at around 36°, in addition to the peak of 2θ at around 31°. The peak of 2θ at around 36° indicates that a crystal having no c-axis alignment is included in a part of the CAAC-OS film. It is preferable that in the CAAC-OS film, a peak of 2θ appear at around 31° and a peak of 2θ not appear at around 36°.

The CAAC-OS film is an oxide semiconductor film having low impurity concentration. The impurity is an element other than the main components of the oxide semiconductor film, such as hydrogen, carbon, silicon, or a transition metal element. In particular, an element that has higher bonding strength to oxygen than a metal element included in the oxide semiconductor film, such as silicon, disturbs the atomic arrangement of the oxide semiconductor film by depriving the oxide semiconductor film of oxygen and causes a decrease in crystallinity. Further, a heavy metal such as iron or nickel, argon, carbon dioxide, or the like has a large atomic radius (molecular radius), and thus disturbs the atomic arrangement of the oxide semiconductor film and causes a decrease in crystallinity when it is contained in the oxide semiconductor film. Note that the impurity contained in the oxide semiconductor film might serve as a carrier trap or a carrier generation source.

The CAAC-OS film is an oxide semiconductor film having a low density of defect states. In some cases, oxygen vacancies in the oxide semiconductor film serve as carrier traps or serve as carrier generation sources when hydrogen is captured therein.

The state in which impurity concentration is low and density of defect states is low (the number of oxygen vacancies is small) is referred to as a “highly purified intrinsic” or “substantially highly purified intrinsic” state. A highly purified intrinsic or substantially highly purified intrinsic oxide semiconductor film has few carrier generation sources, and thus can have a low carrier density. Thus, a transistor including the oxide semiconductor film rarely has negative threshold voltage (is rarely normally on). The highly purified intrinsic or substantially highly purified intrinsic oxide semiconductor film has few carrier traps. Accordingly, the transistor including the oxide semiconductor film has little variation in electrical characteristics and high reliability. Electric charge trapped by the carrier traps in the oxide semiconductor film takes a long time to be released, and might behave like fixed electric charge. Thus, the transistor which includes the oxide semiconductor film having high impurity concentration and a high density of defect states has unstable electrical characteristics in some cases.

With the use of the CAAC-OS film in a transistor, variation in the electrical characteristics of the transistor due to irradiation with visible light or ultraviolet light is small.

Since the OS transistor has a wider band gap than a transistor including silicon in its channel formation region (a Si transistor), dielectric breakdown is unlikely to occur when a high voltage is applied. Although a voltage of several hundreds of volts is generated when battery cells are connected in series, the above-described OS transistor is suitable for a circuit of a battery management unit which is used for such battery cells in the power storage device.

FIG. 23 is an example of a block diagram of the power storage device. A power storage device BT00 illustrated in FIG. 23 includes a terminal pair BT01, a terminal pair BT02, a switching control circuit BT03, a switching circuit BT04, a switching circuit BT05, a voltage transformation control circuit BT06, a voltage transformer circuit BT07, and a battery portion BT08 including a plurality of battery cells BT09 connected in series.

In the power storage device BT00 illustrated in FIG. 23, a portion including the terminal pair BT01, the terminal pair BT02, the switching control circuit BT03, the switching circuit BT04, the switching circuit BT05, the voltage transformation control circuit BT06, and the voltage transformer circuit BT07 can be referred to as a battery management unit.

The switching control circuit BT03 controls operations of the switching circuits BT04 and BT05. Specifically, the switching control circuit BT03 selects battery cells to be discharged (a discharge battery cell group) and battery cells to be charged (a charge battery cell group) in accordance with voltage measured for every battery cell BT09.

Furthermore, the switching control circuit BT03 outputs a control signal S1 and a control signal S2 on the basis of the selected discharge battery cell group and the selected charge battery cell group. The control signal S1 is output to the switching circuit BT04. The control signal S1 controls the switching circuit BT04 so that the terminal pair BT01 and the discharge battery cell group are connected. In addition, the control signal S2 is output to the switching circuit BT05. The control signal S2 controls the switching circuit BT05 so that the terminal pair BT02 and the charge battery cell group are connected.

The switching control circuit BT03 generates the control signal S1 and the control signal S2 on the basis of connection relation of the switching circuit BT04, the switching circuit BT05, and the voltage transformer circuit BT07 so that terminals having the same polarity of the terminal pair BT01 and the discharge battery cell group are connected with each other, or terminals having the same polarity of the terminal pair BT02 and the charge battery cell group are connected with each other.

An operation of the switching control circuit BT03 is described in detail.

First, the switching control circuit BT03 measures the voltage of each of the plurality of battery cells BT09. Then, the switching control circuit BT03 determines that the battery cell BT09 having a voltage higher than a predetermined threshold value is a high-voltage battery cell (high-voltage cell) and that the battery cell BT09 having a voltage lower than the predetermined threshold value is a low-voltage battery cell (low-voltage cell), for example.

As a method to determine whether a battery cell is a high-voltage cell or a low-voltage cell, any of various methods can be employed. For example, the switching control circuit BT03 may determine whether each battery cell BT09 is a high-voltage cell or a low-voltage cell on the basis of the voltage of a battery cell BT09 having a highest voltage or a lowest voltage among the plurality of battery cells BT09. In this case, the switching control circuit BT03 can determine whether each battery cell BT09 is a high-voltage cell or a low-voltage cell by determining whether or not a ratio of a voltage of each battery cell BT09 to the reference voltage is the predetermined value or more. Then, the switching control circuit BT03 determines a charge battery cell group and a discharge battery cell group on the basis of the determination result.

Note that high-voltage cells and low-voltage cells are mixed in various states in the plurality of battery cells BT09. For example, the switching control circuit BT03 selects a portion having the largest number of high-voltage cells connected in series as the discharge battery cell group of mixed high-voltage cells and low-voltage cells. Furthermore, the switching control circuit BT03 selects a portion having the largest number of low-voltage cells connected in series as the charge battery cell group. In addition, the switching control circuit BT03 may preferentially select battery cells BT09 which are near overcharged or overdischarged as the discharge battery cell group or the charge battery cell group.

Here, operation examples of the switching control circuit BT03 in this embodiment are described with reference to FIGS. 24A to 24C. FIGS. 24A to 24C illustrate operation examples of the switching control circuit BT03. Note that FIGS. 24A to 24C each illustrate the case where four battery cells BT09 are connected in series as an example for convenience of explanation.

FIG. 24A shows the case where the relation of voltages Va, Vb, Vc, and Vd is Va=Vb=Vc>Vd where the voltages Va, Vb, Vc, and Vd are voltages of a battery cell a, a battery cell b, a battery cell c, and a battery cell d, respectively. That is, a series of three high-voltage cells a to c and one low-voltage cell d are connected in series. In that case, the switching control circuit BT03 selects the series of three high-voltage cells a to c as the discharge battery cell group. In addition, the switching control circuit BT03 selects the low-voltage cell d as the charge battery cell group.

Next, FIG. 24B shows the case where the relation of the voltages is Vc>Va=Vb>>Vd. That is, a series of two low-voltage cells a and b, one high-voltage cell c, and one low-voltage cell d which is close to overdischarge are connected in series. In that case, the switching control circuit BT03 selects the high-voltage cell c as the discharge battery cell group. Since the low-voltage cell d is close to overdischarge, the switching control circuit BT03 preferentially selects the low-voltage cell d as the charge battery cell group instead of the series of two low-voltage cells a and b.

Lastly, FIG. 24C shows the case where the relation of the voltages is Va>Vb=Vc=Vd. That is, one high-voltage cell a and a series of three low-voltage cells b to d are connected in series. In that case, the switching control circuit BT03 selects the high-voltage cell a as the discharge battery cell group. In addition, the switching control circuit BT03 selects the series of three low-voltage cells b to d as the charge battery cell group.

On the basis of the determination result shown in the examples of FIGS. 24A to 24C, the switching control circuit BT03 outputs the control signal S1 and the control signal S2 to the switching circuit BT04 and the switching circuit BT05, respectively. Information showing the discharge battery cell group being the connection destination of the switching circuit BT04 is set in the control signal S1. Information showing the charge battery cell group being a connection destination of the switching circuit BT05 is set in the control signal S2.

The above is the detailed description of the operation of the switching control circuit BT03.

The switching circuit BT04 sets the discharge battery cell group selected by the switching control circuit BT03 as the connection destination of the terminal pair BT01 in response to the control signal S1 output from the switching control circuit BT03.

The terminal pair BT01 includes a pair of terminals A1 and A2. The switching circuit BT04 sets the connection destination of the terminal pair BT01 by connecting one of the pair of terminals A1 and A2 to a positive electrode terminal of a battery cell BT09 positioned on the most upstream side (on the high potential side) of the discharge battery cell group, and the other to a negative electrode terminal of a battery cell BT09 positioned on the most downstream side (on the low potential side) of the discharge battery cell group. Note that the switching circuit BT04 can recognize the position of the discharge battery cell group on the basis of the information set in the control signal S1.

The switching circuit BT05 sets the charge battery cell group selected by the switching control circuit BT03 as the connection destination of the terminal pair BT02 in response to the control signal S2 output from the switching control circuit BT03.

The terminal pair BT02 includes a pair of terminals B1 and B2. The switching circuit BT05 sets the connection destination of the terminal pair BT02 by connecting one of the pair of terminals B1 and B2 to a positive electrode terminal of a battery cell BT09 positioned on the most upstream side (on the high potential side) of the charge battery cell group, and the other to a negative electrode terminal of a battery cell BT09 positioned on the most downstream side (on the low potential side) of the charge battery cell group. Note that the switching circuit BT05 can recognize the position of the charge battery cell group on the basis of the information set in the control signal S2.

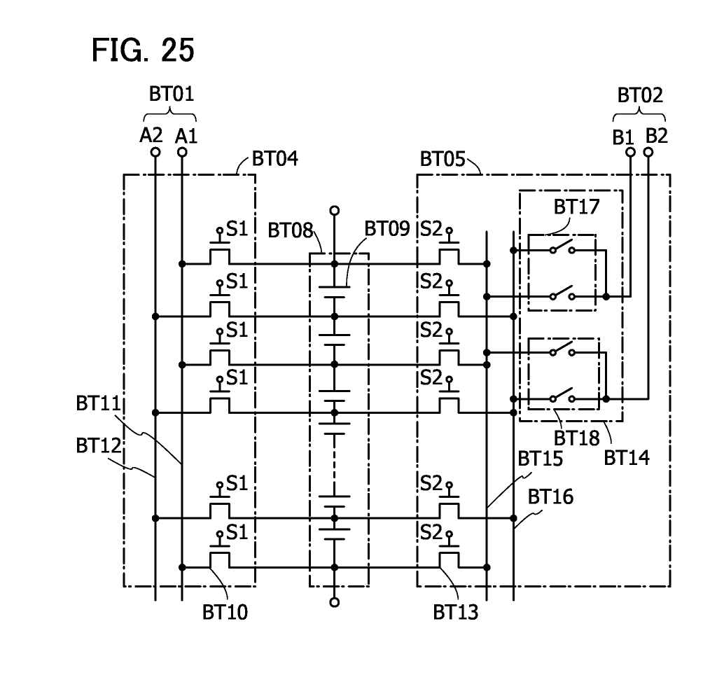

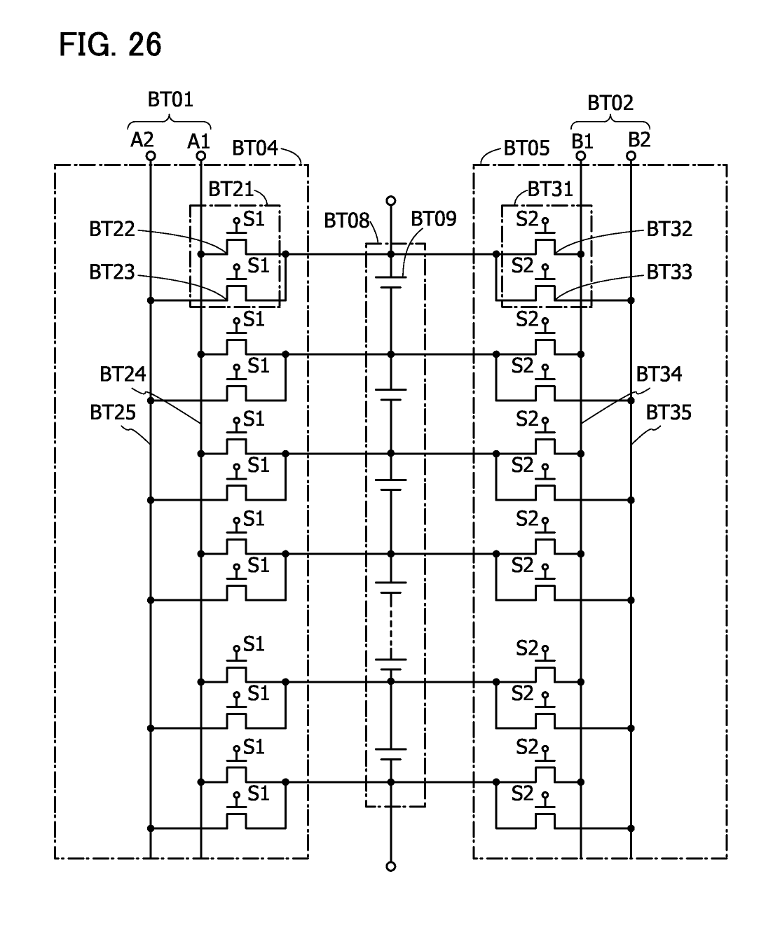

FIG. 25 and FIG. 26 are circuit diagrams showing configuration examples of the switching circuits BT04 and BT05.

In FIG. 25, the switching circuit BT04 includes a plurality of transistors BT10, a bus BT11, and a bus BT12. The bus BT11 is connected to the terminal A1. The bus BT12 is connected to the terminal A2. Sources or drains of the plurality of transistors BT10 are connected alternately to the bus BT11 and the bus BT12. Sources or drains which are not connected to the bus BT11 and the bus BT12 of the plurality of transistors BT10 are each connected between two adjacent battery cells BT09.

A source or a drain of a transistor BT10 which is not connected to the bus BT11 on the most upstream side of the plurality of transistors BT10 is connected to a positive electrode terminal of a battery cell BT09 on the most upstream side of the battery portion BT08. A source or a drain of a transistor BT10 which is not connected to the bus BT11 on the most downstream side of the plurality of transistors BT10 is connected to a negative electrode terminal of a battery cell BT09 on the most downstream side of the battery portion BT08.

The switching circuit BT04 connects the discharge battery cell group to the terminal pair BT01 by bringing one of the plurality of the transistors BT10 which are connected to the bus BT11 and one of the plurality of transistors BT10 which are connected to the bus BT12 into an on state in response to the control signal S1 supplied to gates of the plurality of transistors BT10. Accordingly, the positive electrode terminal of the battery cell BT09 on the most upstream side of the discharge battery cell group is connected to one of the pair of terminals A1 and A2. In addition, the negative electrode terminal of the battery cell BT09 on the most downstream side of the discharge battery cell group is connected to the other of the pair of terminals A1 and A2 (i.e., a terminal which is not connected to the positive electrode terminal).

An OS transistor is preferably used as the transistor BT10. Since the off-state current of the OS transistor is low, the amount of electric charge leaking from battery cells which do not belong to the discharge battery cell group can be reduced, and reduction in capacity over time can be suppressed. In addition, dielectric breakdown is unlikely to occur in the OS transistor when a high voltage is applied. Therefore, the battery cell BT09 and the terminal pair BT01, which are connected to the transistor BT10 in an off state, can be insulated from each other even when an output voltage of the discharge battery cell group is high.

In FIG. 25, the switching circuit BT05 includes a plurality of transistors BT13, a current control switch BT14, a bus BT15, and a bus BT16. The bus BT15 and the bus BT16 are provided between the plurality of transistors BT13 and the current control switch BT14. Sources or drains of the plurality of transistors BT13 are connected alternately to the bus BT15 and the bus BT16. Sources or drains which are not connected to the bus BT15 and the bus BT16 of the plurality of transistors BT13 are each connected between two adjacent battery cells BT09.

A source or a drain of a transistor BT13 which is not connected to the bus BT15 on the most upstream side of the plurality of transistors BT13 is connected to a positive electrode terminal of the battery cell BT09 on the most upstream side of the battery portion BT08. A source or a drain of a transistor BT13 which is not connected to the bus BT15 on the most downstream side of the plurality of transistors BT13 is connected to a negative electrode terminal of the battery cell BT09 on the most downstream side of the battery portion BT08.

OS transistors are preferably used as the transistors BT13 like the transistors BT10. Since the off-state current of the OS transistor is low, the amount of electric charge leaking from the battery cells which do not belong to the charge battery cell group can be reduced, and reduction in capacity over time can be suppressed. In addition, dielectric breakdown is unlikely to occur in the OS transistor when a high voltage is applied. Therefore, the battery cell BT09 and the terminal pair BT02, which are connected to the transistor BT13 in an off state, can be insulated from each other even when a voltage for charging the charge battery cell group is high.

The current control switch BT14 includes a switch pair BT17 and a switch pair BT18. One end of the switch pair BT17 is connected to the terminal B1. The other ends of the switch pair BT17 extend from respective switches of the switch pair BT17. One switch is connected to the bus BT15, and the other switch is connected to the bus BT16. One end of the switch pair BT18 is connected to the terminal B2. The other ends of the switch pair BT18 extend from two switches of the switch pair BT18. One switch is connected to the bus BT15, and the other switch is connected to the bus BT16.

OS transistors are preferably used for the switches included in the switch pair BT17 and the switch pair BT18 like the transistors BT10 and BT13.

The switching circuit BT05 connects the charge battery cell group and the terminal pair BT02 by controlling the combination of on and off states of the transistors BT13 and the current control switch BT14 in response to the control signal S2.

For example, the switching circuit BT05 connects the charge battery cell group and the terminal pair BT02 in the following manner.

The switching circuit BT05 brings a transistor BT13 connected to a positive electrode terminal of a battery cell BT09 on the most upstream side of the charge battery cell group into an on state in response to the control signal S2 supplied to gates of the plurality of the transistors BT13. In addition, the switching circuit BT05 brings a transistor BT13 connected to a negative electrode terminal of a battery cell BT09 on the most downstream side of the charge battery cell group into an on state in response to the control signal S2 supplied to the gates of the plurality of the transistors BT13.

The polarities of voltages applied to the terminal pair BT02 can vary in accordance with the connection structures of the voltage transformer circuit BT07 and the discharge battery cell group connected to the terminal pair BT01. In order to supply current in a direction for charging the charge battery cell group, terminals with the same polarity of the terminal pair BT02 and the charge battery cell group are required to be connected. In view of this, the current control switch BT14 is controlled by the control signal S2 so that the connection destination of the switch pair BT17 and that of the switch pair BT18 are changed in accordance with the polarities of the voltages applied to the terminal pair BT02.

The state where voltages are applied to the terminal pair BT02 so as to make the terminal B1 a positive electrode and the terminal B2 a negative electrode is described as an example. Here, in the case where the battery cell BT09 positioned on the most downstream side of the battery portion BT08 is in the charge battery cell group, the switch pair BT17 is controlled to be connected to the positive electrode terminal of the battery cell BT09 in response to the control signal S2. That is, the switch of the switch pair BT17 connected to the bus BT16 is turned on, and the switch of the switch pair BT17 connected to the bus BT15 is turned off. In contrast, the switch pair BT18 is controlled to be connected to the negative electrode terminal of the battery cell BT09 positioned on the most downstream side of the battery portion BT08 in response to the control signal S2. That is, the switch of the switch pair BT18 connected to the bus BT15 is turned on, and the switch of the switch pair BT18 connected to the bus BT16 is turned off. In this manner, terminals with the same polarity of the terminal pair BT02 and the charge battery cell group are connected to each other. In addition, the current which flows from the terminal pair BT02 is controlled to be supplied in a direction so as to charge the charge battery cell group.

In addition, instead of the switching circuit BT05, the switching circuit BT04 may include the current control switch BT14. In that case, the polarities of the voltages applied to the terminal pair BT02 are controlled by controlling the polarities of the voltages applied to the terminal pair BT01 in response to the operation of the current control switch BT14 and the control signal S1. Thus, the current control switch BT14 controls the direction of current which flows to the charge battery cell group from the terminal pair BT02.

FIG. 26 is a circuit diagram illustrating structure examples of the switching circuit BT04 and the switching circuit BT05 which are different from those of FIG. 25.

In FIG. 26, the switching circuit BT04 includes a plurality of transistor pairs BT21, a bus BT24, and a bus BT25. The bus BT24 is connected to the terminal A1. The bus BT25 is connected to the terminal A2. One end of each of the plurality of transistor pairs BT21 extends from a transistor BT22 and a transistor BT23. A source or drain of the transistor BT22 is connected to the bus BT24. A source or drain of the transistor BT23 is connected to the bus BT25. In addition, the other end of each of the transistor pairs BT21 is connected between two adjacent battery cells BT09. The other end of the transistor pair BT21 on the most upstream side of the plurality of transistor pairs BT21 is connected to the positive electrode terminal of the battery cell BT09 on the most upstream side of the battery portion BT08. The other end of the transistor pair BT21 on the most downstream side of the plurality of transistor pairs BT21 is connected to the negative electrode terminal of the battery cell BT09 on the most downstream side of the battery portion BT08.

The switching circuit BT04 switches the connection destination of the transistor pair BT21 to one of the terminal A1 and the terminal A2 by turning on or off the transistors BT22 and BT23 in response to the control signal S1. Specifically, when the transistor BT22 is turned on, the transistor BT23 is turned off, so that the connection destination of the transistor pair BT21 is the terminal A1. On the other hand, when the transistor BT23 is turned on, the transistor BT22 is turned off, so that the connection destination of the transistor pair BT21 is the terminal A2. Which of the transistors BT22 and BT23 is turned on is determined by the control signal S1.

Two transistor pairs BT21 are used to connect the terminal pair BT01 and the discharge battery cell group. Specifically, the connection destinations of the two transistor pairs BT21 are determined on the basis of the control signal S1, and the discharge battery cell group and the terminal pair BT01 are connected. The connection destinations of the two transistor pairs BT21 are controlled by the control signal S1 so that one of the connection destinations is the terminal A1 and the other is the terminal A2.

The switching circuit BT05 includes a plurality of transistor pairs BT31, a bus BT34, and a bus BT35. The bus BT34 is connected to the terminal B1. The bus BT35 is connected to the terminal B2. One ends of the transistor pairs BT31 extend from a transistor BT32 and a transistor BT33. One end extending from the transistor BT32 is connected to the bus BT34. One end extending from the transistor BT33 is connected to the bus BT35. The other end of each of the transistor pairs BT31 is connected between two adjacent battery cells BT09. The other end of the transistor pair BT31 on the most upstream side of the plurality of transistor pairs BT31 is connected to the positive electrode terminal of the battery cell BT09 on the most upstream side of the battery portion BT08. The other end of the transistor pair BT31 on the most downstream side of the plurality of transistor pairs BT31 is connected to the negative electrode terminal of the battery cell BT09 on the most downstream side of the battery portion BT08.

The switching circuit BT05 switches the connection destination of the transistor pair BT31 to one of the terminal B1 and the terminal B2 by turning on or off the transistors BT32 and BT33 in response to the control signal S2. Specifically, when the transistor BT32 is turned on, the transistor BT33 is turned off, so that the connection destination of the transistor pair BT31 is the terminal B1. On the other hand, when the transistor BT33 is turned on, the transistor BT32 is turned off, so that the connection destination of the transistor pair BT31 is the terminal B2. Which of the transistors BT32 and BT33 is turned on is determined by the control signal S2.

Two transistor pairs BT31 are used to connect the terminal pair BT02 and the charge battery cell group. Specifically, the connection destinations of the two transistor pairs BT31 are determined on the basis of the control signal S2, and the charge battery cell group and the terminal pair BT02 are connected. The connection destinations of the two transistor pairs BT31 are controlled by the control signal S2 so that one of the connection destinations is the terminal B1 and the other is the terminal B2.

The connection destinations of the two transistor pairs BT31 are determined by the polarities of the voltages applied to the terminal pair BT02. Specifically, in the case where voltages which make the terminal B1 a positive electrode and the terminal B2 a negative electrode are applied to the terminal pair BT02, the transistor pair BT31 on the upstream side is controlled by the control signal S2 so that the transistor BT32 is turned on and the transistor BT33 is turned off. In contrast, the transistor pair BT31 on the downstream side is controlled by the control signal S2 so that the transistor BT33 is turned on and the transistor BT32 is turned off. In the case where voltages which make the terminal B1 a negative electrode and the terminal B2 a positive electrode are applied to the terminal pair BT02, the transistor pair BT31 on the upstream side is controlled by the control signal S2 so that the transistor BT33 is turned on and the transistor BT32 is turned off. In contrast, the transistor pair BT31 on the downstream side is controlled by the control signal S2 so that the transistor BT32 is turned on and the transistor BT33 is turned off. In this manner, terminals with the same polarity of the terminal pair BT02 and the charge battery cell group are connected to each other. In addition, the current which flows from the terminal pair BT02 is controlled to be supplied in a direction for charging the charge battery cell group.

The voltage transformation control circuit BT06 controls operation of the voltage transformer circuit BT07. The voltage transformation control circuit BT06 generates a voltage transformation signal S3 for controlling the operation of the voltage transformer circuit BT07 on the basis of the number of the battery cells BT09 included in the discharge battery cell group and the number of the battery cells BT09 included in the charge battery cell group and outputs the voltage transformation signal S3 to the voltage transformer circuit BT07.

In the case where the number of the battery cells BT09 included in the discharge battery cell group is larger than that included in the charge battery cell group, it is necessary to inhibit a charging voltage which is too high from being applied to the charge battery cell group. Thus, the voltage transformation control circuit BT06 outputs the voltage transformation signal S3 for controlling the voltage transformer circuit BT07 so that a discharging voltage (Vdis) is lowered within a range where the charge battery cell group can be charged.

In the case where the number of the battery cells BT09 included in the discharge battery cell group is less than or equal to that included in the charge battery cell group, a voltage necessary for charging the charge battery cell group needs to be secured. Therefore, the voltage transformation control circuit BT06 outputs the voltage transformation signal S3 for controlling the voltage transformer circuit BT07 so that the discharging voltage (Vdis) is raised within a range where a charging voltage which is too high is not applied to the charge battery cell group.

The voltage value of the charging voltage which is too high is determined in the light of product specifications and the like of the battery cell BT09 used in the battery portion BT08. The voltage which is raised or lowered by the voltage transformer circuit BT07 is applied as a charging voltage (Vcha) to the terminal pair BT02.

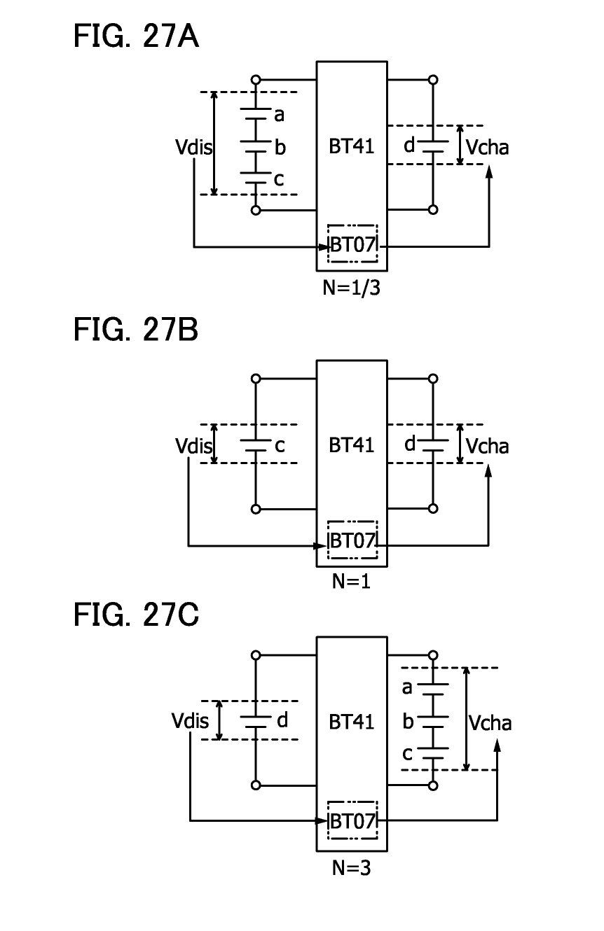

Here, operation examples of the voltage transformation control circuit BT06 in this embodiment are described with reference to FIGS. 27A to 27C. FIGS. 27A to 27C are conceptual diagrams for explaining the operation examples of the voltage transformation control circuit BT06 corresponding to the discharge battery cell group and the charge battery cell group described in FIGS. 24A to 24C. FIGS. 27A to 27C each illustrate a battery management unit BT41. The battery management unit BT41 includes the terminal pair BT01, the terminal pair BT02, the switching control circuit BT03, the switching circuit BT04, the switching circuit BT05, the voltage transformation control circuit BT06, and the voltage transformer circuit BT07.

In an example illustrated in FIG. 27A, the series of three high-voltage cells a to c and one low-voltage cell d are connected in series as described in FIG. 24A. In that case, as described using FIG. 24A, the switching control circuit BT03 selects the high-voltage cells a to c as the discharge battery cell group, and selects the low-voltage cell d as the charge battery cell group. The voltage transformation control circuit BT06 calculates a conversion ratio N for converting the discharging voltage (Vdis) to the charging voltage (Vcha) on the basis of the ratio of the number of the battery cells BT09 included in the charge battery cell group to the number of the battery cells BT09 included in the discharge battery cell group.

In the case where the number of the battery cells BT09 included in the discharge battery cell group is larger than that included in the charge battery cell group, when a discharging voltage is applied to the terminal pair BT02 without transforming the voltage, overvoltage may be applied to the battery cells BT09 included in the charge battery cell group through the terminal pair BT02. Thus, in the case of FIG. 27A, it is necessary that a charging voltage (Vcha) applied to the terminal pair BT02 be lowered than the discharging voltage. In addition, in order to charge the charge battery cell group, it is necessary that the charging voltage be higher than the total voltage of the battery cells BT09 included in the charge battery cell group. Thus, the transformation control circuit BT06 sets the conversion ratio N larger than the ratio of the number of the battery cells BT09 included in the charge battery cell group to the number of the battery cells BT09 included in the discharge battery cell group.

Thus, the voltage transformation control circuit BT06 preferably sets the conversion ratio N larger than the ratio of the number of the battery cells BT09 included in the charge battery cell group to the number of the battery cells BT09 included in the discharge battery cell group by about 1% to 10%. Here, the charging voltage is made higher than the voltage of the charge battery cell group, but the charging voltage is equal to the voltage of the charge battery cell group in reality. Note that the voltage transformation control circuit BT06 feeds a current for charging the charge battery cell group in accordance with the conversion ratio N in order to make the voltage of the charge battery cell group equal to the charging voltage. The value of the current is set by the voltage transformation control circuit BT06.

In the example illustrated in FIG. 27A, since the number of the battery cells BT09 included in the discharge battery cell group is three and the number of the battery cells BT09 included in the charge battery cell group is one, the voltage transformation control circuit BT06 calculates a value which is slightly larger than ⅓ as the conversion ratio N. Then, the voltage transformation control circuit BT06 outputs the voltage transformation signal S3, which lowers the discharging voltage in accordance with the conversion ratio N and converts the voltage into a charging voltage, to the voltage transformer circuit BT07. The voltage transformer circuit BT07 applies the charging voltage which is transformed in response to the voltage transformation signal S3 to the terminal pair BT02. Then, the battery cells BT09 included in the charge battery cell group are charged with the charging voltage applied to the terminal pair BT02.

In each of examples illustrated in FIGS. 27B and 27C, the conversion ratio N is calculated in a manner similar to that of FIG. 27A. In each of the examples illustrated in FIGS. 27B and 27C, since the number of the battery cells BT09 included in the discharge battery cell group is less than or equal to the number of the battery cells BT09 included in the charge battery cell group, the conversion ratio N is 1 or more. Therefore, in this case, the voltage transformation control circuit BT06 outputs the voltage transformation signal S3 for raising the discharging voltage and converting the voltage into the charging voltage.

The voltage transformer circuit BT07 converts the discharging voltage applied to the terminal pair BT01 into a charging voltage on the basis of the voltage transformation signal S3. The voltage transformer circuit BT07 applies the converted charging voltage to the terminal pair BT02. Here, the voltage transformer circuit BT07 electrically insulates the terminal pair BT01 from the terminal pair BT02. Accordingly, the voltage transformer circuit BT07 inhibits a short circuit due to a difference between the absolute voltage of the negative electrode terminal of the battery cell BT09 on the most downstream side of the discharge battery cell group and the absolute voltage of the negative electrode terminal of the battery cell BT09 on the most downstream side of the charge battery cell group. Furthermore, the voltage transformer circuit BT07 converts the discharging voltage, which is the total voltage of the discharge battery cell group, into the charging voltage on the basis of the voltage transformation signal S3 as described above.

An insulated direct current (DC)-DC converter or the like can be used in the voltage transformer circuit BT07. In that case, the voltage transformation control circuit BT06 controls the charging voltage converted by the voltage transformer circuit BT07 by outputting a signal for controlling the on/off ratio (the duty ratio) of the insulated DC-DC converter as the voltage transformation signal S3.

Examples of the insulated DC-DC converter include a flyback converter, a forward converter, a ringing choke converter (RCC), a push-pull converter, a half-bridge converter, and a full-bridge converter, and a suitable converter is selected in accordance with the value of the intended output voltage.

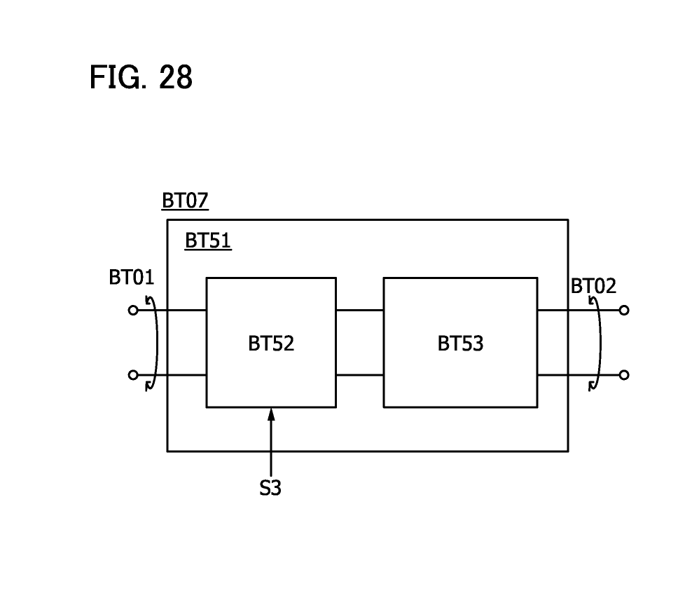

The structure of the voltage transformer circuit BT07 including the insulated DC-DC converter is illustrated in FIG. 28. An insulated DC-DC converter BT51 includes a switch portion BT52 and a transformer BT53. The switch portion BT52 is a switch for switching on/off of the operation of the insulated DC-DC converter, and a metal oxide semiconductor field-effect transistor (MOSFET), a bipolar transistor, or the like is used as the switch portion BT52. The switch portion BT52 periodically turns on and off the insulated DC-DC converter BT51 in accordance with the voltage transformation signal S3 controlling the on/off ratio which is output from the voltage transformation control circuit BT06. The switch portion BT52 can have any of various structures in accordance with the type of the insulated DC-DC converter which is used. The transformer BT53 converts the discharging voltage applied from the terminal pair BT01 into the charging voltage. In detail, the transformer BT53 operates in conjunction with the on/off state of the switch portion BT52 and converts the discharging voltage into the charging voltage in accordance with the on/off ratio. As the time during which the switch portion BT52 is on becomes longer in its switching period, the charging voltage is increased. On the other hand, as the time during which the switch portion BT52 is on becomes shorter in its switching period, the charging voltage is decreased. In the case where the insulated DC-DC converter is used, the terminal pair BT01 and the terminal pair BT02 can be insulated from each other inside the transformer BT53.

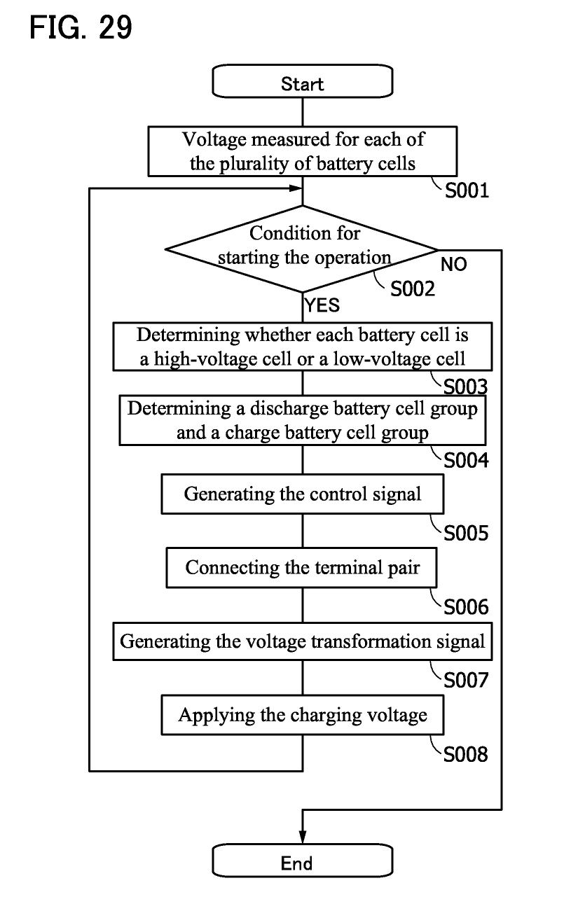

A flow of operation of the power storage device BT00 in this embodiment is described with reference to FIG. 29. FIG. 29 is a flow chart illustrating the flow of the operation of the power storage device BT00.

First, the power storage device BT00 obtains a voltage measured for each of the plurality of battery cells BT09 (step S001). Then, the power storage device BT00 determines whether or not the condition for starting the operation of reducing variation in voltages of the plurality of the battery cells BT09 is satisfied (step S002). An example of the starting condition can be that the difference between the maximum value and the minimum value of the voltage measured for each of the plurality of the battery cells BT09 is higher than or equal to the predetermined threshold value. In the case where the starting condition is not satisfied (step S002: NO), the power storage device BT00 does not perform the following operation because voltages of the battery cells BT09 are well balanced. In contrast, in the case where the condition is satisfied (step S002: YES), the power storage device BT00 performs the operation of reducing variation in the voltages of the battery cells BT09. In this operation, the power storage device BT00 determines whether each battery cell BT09 is a high-voltage cell or a low-voltage cell on the basis of the measured voltage of each cell (step S003). Then, the power storage device BT00 determines a discharge battery cell group and a charge battery cell group on the basis of the determination result (step S004). In addition, the power storage device BT00 generates the control signal S1 for setting the determined discharge battery cell group as the connection destination of the terminal pair BT01, and the control signal S2 for setting the determined charge battery cell group as the connection destination of the terminal pair BT02 (step S005). The power storage device BT00 outputs the generated control signals S1 and S2 to the switching circuit BT04 and the switching circuit BT05, respectively. Then, the switching circuit BT04 connects the terminal pair BT01 and the discharge battery cell group, and the switching circuit BT05 connects the terminal pair BT02 and the discharge battery cell group (step S006). The power storage device BT00 generates the voltage transformation signal S3 based on the number of the battery cells BT09 included in the discharge battery cell group and the number of the battery cells BT09 included in the charge battery cell group (step S007). Then, the power storage device BT00 converts the discharging voltage applied to the terminal pair BT01 into a charging voltage based on the voltage transformation signal S3 and applies the charging voltage to the terminal pair BT02 (step S008). In this way, electric charge of the discharge battery cell group is transferred to the charge battery cell group.

Although the plurality of steps are shown in order in the flow chart of FIG. 29, the order of performing the steps is not limited to the order.

According to the above embodiment, when an electric charge is transferred from the discharge battery cell group to the charge battery cell group, a structure where an electric charge from the discharge battery cell group is temporarily stored, and the stored electric charge is sent to the charge battery cell group is unnecessary, unlike in the a capacitor type circuit. Accordingly, the charge transfer efficiency per unit time can be increased. In addition, the switching circuit BT04 and the switching circuit BT05 determine which battery cell in the discharge battery cell group and the charge battery cell group to be connected to the voltage transformer circuit.

Furthermore, the voltage transformer circuit BT07 converts the discharging voltage applied to the terminal pair BT01 into the charging voltage based on the number of the battery cells BT09 included in the discharge battery cell group and the number of the battery cells BT09 included in the charge battery cell group, and applies the charging voltage to the terminal pair BT02. Thus, even when any battery cell BT09 is selected as the discharge battery cell group and the charge battery cell group, an electric charge can be transferred without any problems.

Furthermore, the use of OS transistors as the transistor BT10 and the transistor BT13 can reduce the amount of electric charge leaking from the battery cells BT09 which do not belong to the charge battery cell group or the discharge battery cell group. Accordingly, a decrease in capacity of the battery cells BT09 which do not contribute to charging or discharging can be suppressed. In addition, the variation in characteristics of the OS transistor due to heat is smaller than that of an Si transistor. Accordingly, even when the temperature of the battery cells BT09 is increased, an operation such as turning on or off the transistors in response to the control signals S1 and S2 can be performed normally.

### Example 1

In this example, a storage battery of one embodiment of the present invention was fabricated on the basis of Embodiment 1, and subjected to a cycle life test together with a storage battery for comparison.

### <Structure of Storage Battery 1>

The structure of the fabricated storage battery 1 will be described.

### [Formation of Positive Electrode A]

First, a positive electrode slurry containing graphene as a conductive additive was formed. Lithium iron phosphate (LiFePO₄) was used as a positive electrode active material, and polyvinylidene fluoride (PVdF) was used as a binder. Lithium iron phosphate, graphene oxide, and polyvinylidene fluoride were mixed at a weight ratio of 94.2:0.8:5.0. Then, N-methyl pyrrolidone (NMP) was added as a dispersion medium to adjust the viscosity, and mixing was performed. Thus, the positive electrode slurry was formed.

The positive electrode slurry formed by the above method was applied to a positive electrode current collector (20-μm-thick aluminum) using a micro bar coater.

Subsequently, the slurry provided on the current collector was dried in a drying chamber of the coater. The drying was performed at 65° C. in an air atmosphere for 15 minutes, and then performed at 75° C. in an air atmosphere for 15 minutes.

Subsequently, graphene oxide was reduced by reaction in a solvent containing a reducer. The reduction treatment was performed at 60° C. for 1 hour. Ascorbic acid was used as the reducer. As the solvent, NMP was used. The concentration of the reducer was 13.5 g/L.

After that, cleaning with ethanol was performed, and drying was performed at 170° C. for 10 hours. The drying was performed in a vacuum atmosphere. Note that this step also serves as thermal reduction of graphene oxide

Subsequently, the positive electrode active material layer was pressed by a roll press method so as to be consolidated.

A positive electrode A used for the storage battery 1 was formed in the above manner. The amount of lithium iron phosphate in this positive electrode was 11.1 mg/cm².

### [Formation of Negative Electrode A]

A negative electrode slurry was formed with the use of a negative electrode active material, a conductive additive, a binder, and a dispersion medium. As the negative electrode active material, artificial graphite (MCMB) with a grain diameter of 10 μm was used. As the conductive additive, vapor-grown carbon fiber VGCF (registered trademark) was used. As the binder, sodium carboxymethyl cellulose (CMC-Na) and styrene butadiene rubber (SBR) were used. Water was used as the dispersion medium of the slurry. The negative electrode slurry was obtained in such a manner that the artificial graphite, VGCF (registered trademark), CMC-Na, and SBR were mixed in water so that the weight ratio thereof was 96:1:1:2.

The negative electrode slurry formed by the above method was applied to a negative electrode current collector (18-μm-thick rolled copper foil) using a micro bar coater.

Subsequently, the slurry applied to the current collector was dried in a drying chamber of the coater. The drying was performed at 50° C. in an air atmosphere for 90 seconds and further performed at 80° C. in an air atmosphere for 90 seconds.

The negative electrode A used for the storage battery 1 was formed in the above manner. The amount of graphite in this negative electrode was 11.1 g/cm².

### [Formation of Positive Electrode B]

First, a positive electrode slurry containing graphene as a conductive additive was formed. Lithium iron phosphate (LiFePO₄) was used as a positive electrode active material, and polyvinylidene fluoride (PVdF) was used as a binder. Lithium iron phosphate, graphene oxide, and polyvinylidene fluoride were mixed at a weight ratio of 94.2:0.8:5.0. Then, N-methyl pyrrolidone (NMP) was added as a dispersion medium to adjust the viscosity, and mixing was performed. Thus, the positive electrode slurry was formed.

The positive electrode slurry formed by the above method was applied to a positive electrode current collector (20-μm-thick aluminum) using a micro bar coater.

Subsequently, the slurry provided on the current collector was dried in a drying chamber of the coater. The drying was performed in an air atmosphere at 80° C. for 4 minutes, and then performed in an air atmosphere at 120° C. for 8 minutes.

Next, drying was performed at 170° C. for 10 hours. The drying was performed in a vacuum atmosphere. In this step, thermal reduction of graphene oxide was performed in addition to drying of the electrode.

Subsequently, the positive electrode active material layer was pressed by a roll press method so as to be consolidated.

A positive electrode B used for the comparative storage battery 1 was formed in the above manner. The amount of lithium iron phosphate in this positive electrode was 11.3 mg/cm².

### [Formation of Negative Electrode B]

A negative electrode slurry was formed with the use of a negative electrode active material, a binder, and a dispersion medium. As the negative electrode active material, artificial graphite (MCMB) with a grain diameter of 10 μm was used. As the binder, sodium carboxymethyl cellulose (CMC-Na) and styrene butadiene rubber (SBR) were used. Water was used as the dispersion medium of the slurry. The negative electrode slurry was obtained in such a manner that the artificial graphite, CMC-Na, and SBR were mixed in water so that the weight ratio thereof was 97:1:2.

The negative electrode slurry formed by the above method was applied to a negative electrode current collector (18-μm-thick rolled copper foil) using a micro bar coater.

Subsequently, the slurry applied to the current collector was dried in a drying chamber of the coater. The drying was performed at 80° C. in an air atmosphere for 4 minutes and further performed at 120° C. in an air atmosphere for 8 minutes.

The negative electrode B used for the comparative storage battery 1 was formed in the above manner. The amount of graphite in this negative electrode was 5.5 g/cm².

### [Electrolyte Solution A]

The electrolyte solution was formed in such a manner that EC and DEC were mixed at a volume ratio of 1:1 so as to be a solvent, LiTFSA was dissolved as a lithium salt at a concentration of 0.65 mol/kg, and then, 2 wt % of LiPF₆ and 1 wt % of vinylene carbonate (VC) were added as additives. The electrolyte solution is an electrolyte solution A. Note that LiPF₆ as the additive is added to inhibit corrosion of Al included in the positive electrode current collector.

### [Electrolyte Solution B]

The electrolyte solution was formed in such a manner that EC and DEC were mixed at a volume ratio of 3:7 so as to be a solvent, LiPF₆ was dissolved as a lithium salt at a concentration of 1 mol/L, and then, 1 wt % of VC were added as additives. The electrolyte solution is an electrolyte solution B.

### [Fabrication of Storage Battery 1]

A laminated storage battery was fabricated with the use of the formed positive electrode A, negative electrode A, and electrolyte solution A. An aluminum film covered with a heat sealing resin was used as an exterior body. As a separator, 25-μm-thick polypropylene (PP) was used. The laminated storage battery is the storage battery 1.

### [Fabrication of Comparative Storage Battery 1]

Next, a laminated storage battery was fabricated with the use of the formed positive electrode B, negative electrode B, and electrolyte solution B. An aluminum film covered with a heat sealing resin was used as an exterior body. As a separator, 25-μm-thick polypropylene (PP) was used. The laminated storage battery is the comparative storage battery 1.

Next, the fabricated storage battery 1 and comparative storage battery 1 were subjected to aging. First, the storage batteries were charged to 3.2 V at a rate of 0.01 C at 25° C., and then gas in the storage battery was released outside the exterior body in a glove box. After that, the storage batteries were resealed and charged at 25° C. The charge was performed by CCCV, specifically, in such a manner that a voltage was applied at a constant current of 0.1 C until the voltage increased and reached 4.0 V and then a constant voltage of 4.0 V was maintained until the current value reached 0.01 C. After that, the storage batteries were kept at 40° C. for 24 hours and discharged at 25° C. with the lower limit set to 2 V. After that, the storage batteries were charged and discharged at a rate of 0.2 C twice with a voltage ranging from 2.0 V to 4.0 V at 25° C.

A main difference between the storage battery 1 and the comparative storage battery 1 is that the main component of the electrolyte is LiTFSA in the storage battery 1 and that is LiPF₆ in the comparative storage battery 1.

### <Cycle Life of Storage Battery 1 and Comparative Storage Battery 1>

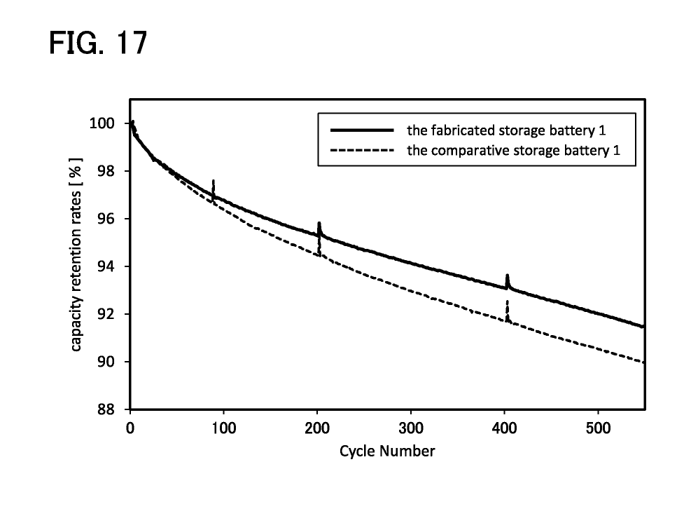

Next, a cycle life test will be described. The test was performed at 60° C. Charge and discharge were performed at a rate of 0.5 C. FIG. 17 shows changes in the capacity retention rates of the fabricated storage battery 1 and comparative storage battery 1 in the case of repeating charge and discharge. As shown in FIG. 17, a decrease in capacity retention rates with repeated cycles is large in the comparative storage battery 1, whereas that in the storage battery 1 is relatively small. The storage battery 1 has a favorable cycle performance compared with the comparative storage battery 1.

### <XPS Analysis>

After the above cycle life test at 60° C., the storage batteries were disassembled and the negative electrodes were taken out and subjected to surface analysis by X-ray photoelectron spectroscopy (XPS). The negative electrodes taken out of the storage batteries were washed with DMC and dried, and then subjected to the analysis. The XPS analysis was performed so that the samples were not exposed to air.

The conditions of XPS analysis will be described. The apparatus used for XPS analysis was Quantera SXM manufactured by PHYSICAL ELECTRONICS, INC. Monochromatic Al Kα ray (1486.6 eV) was used for an X-ray source. A detection area was set to 100 μmφ and the detection depth was set to greater than or equal to approximately 4 nm and less than or equal to 5 nm (an extraction angle of 45°).

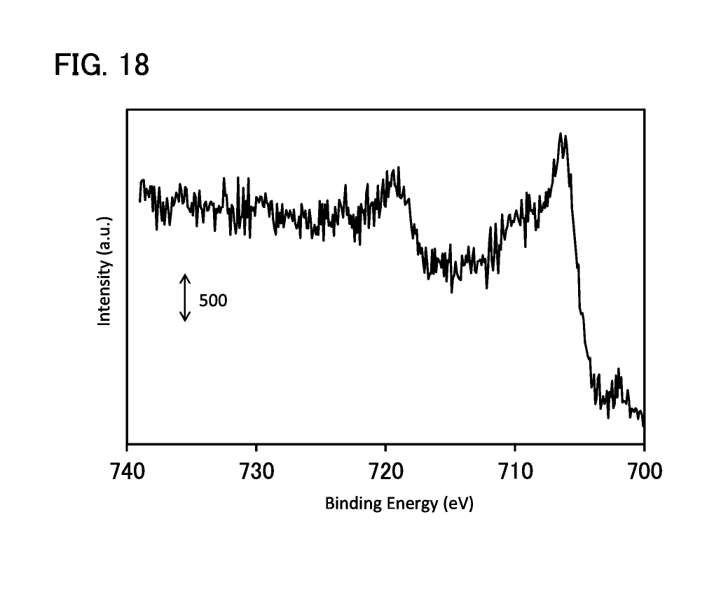

First, FIG. 18 shows a spectrum from 700 eV to 740 eV obtained by the XPS analysis of a surface of the negative electrode taken out of the comparative storage battery 1. In this range, a peak attributed to the 2p orbital of Fe is observed. A peak derived from Fe as a metal state is observed (around 706 eV) in the spectrum shown in FIG. 18, which indicates the existence of a zero-valent Fe on the surface of the negative electrode of the comparative storage battery 1. In the comparative storage battery 1, Fe was not used but for the positive electrode active material; thus, it is suggested that Fe included in the positive electrode active material is dissolved and transferred in the electrolyte solution as Fe ions, and reduced and deposited on the surface of the negative electrode. That is, the positive electrode active material was damaged by the electrolyte solution. The charge in the comparative storage battery 1 was presumably wasted when Fe ions were reduced on the surface of the negative electrode.

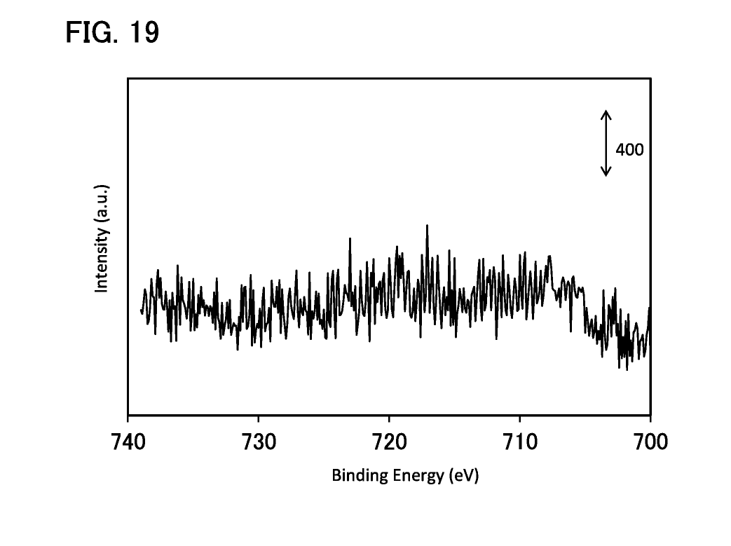

Next, FIG. 19 shows in a similar manner the result of the XPS analysis of a surface of the negative electrode taken out of the storage battery 1. Although the spectrum in FIG. 19 has a noise level similar to that of the spectrum in FIG. 18, the spectrum in FIG. 19 does not have a peak showing the signal intensity over the noise level in this range unlike the spectrum in FIG. 18. Therefore, it is shown that Fe is not observed on the surface of the negative electrode in the storage battery 1 at least by the XPS analysis. This is because the electrolyte solution in which LiTFSA is dissolved does not dissolve Fe included in the positive electrode active material in the storage battery 1 unlike the electrolyte solution in which LiPF₆ is dissolved, that is, the LiTFSA electrolyte solution does not cause deterioration of the positive electrode active material.

### <Cross-Sectional TEM Observation>

Next, in order to observe the particle surface of LiFePO₄ included in the positive electrode, a cross section thereof was observed with a transmission electron microscope (TEM). The TEM observation was performed with H-9000NAR manufactured by Hitachi High-Technologies Corporation. A sample which was thinned by a focused ion beam (FIB) method was used. The analysis sample was not exposed to air during a series of the FIB process and the TEM observation.

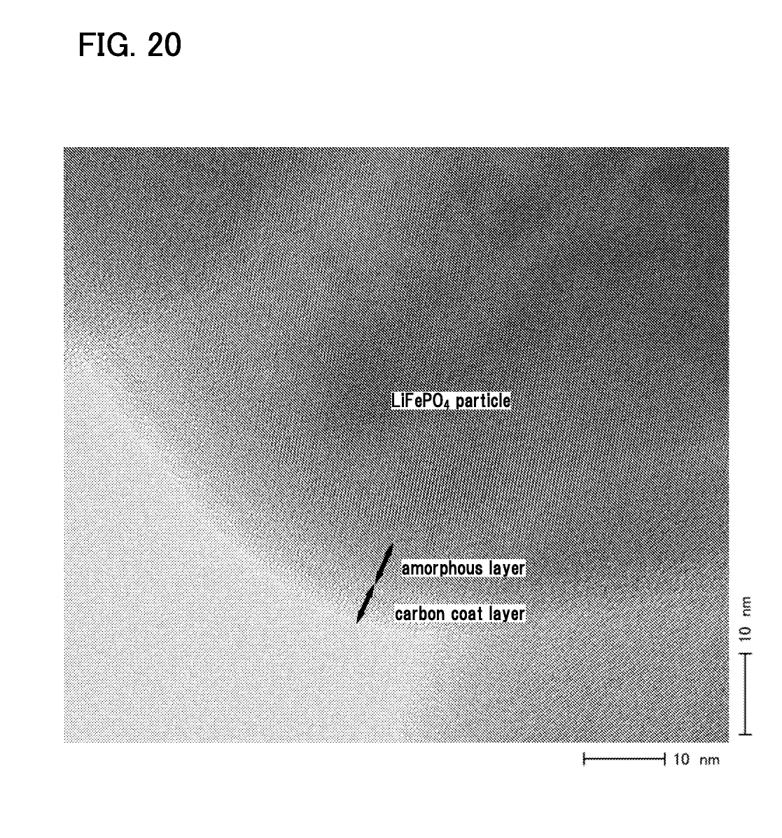

FIG. 20 is a cross-sectional TEM image of the vicinity of the surface of the positive electrode which was taken out of the comparative storage battery 1 (observed at an accelerating voltage of 200 kV and at an observation magnification of 2,050,000 times). FIG. 20 shows that a layer in which lattice fringes were not observed was formed on the surface of a LiFePO₄ particle of the positive electrode active material. That is, an amorphous layer was formed on the surface of LiFePO₄ particle, which suggests that the surface of the positive electrode active material deteriorated due to reaction with the electrolyte solution.

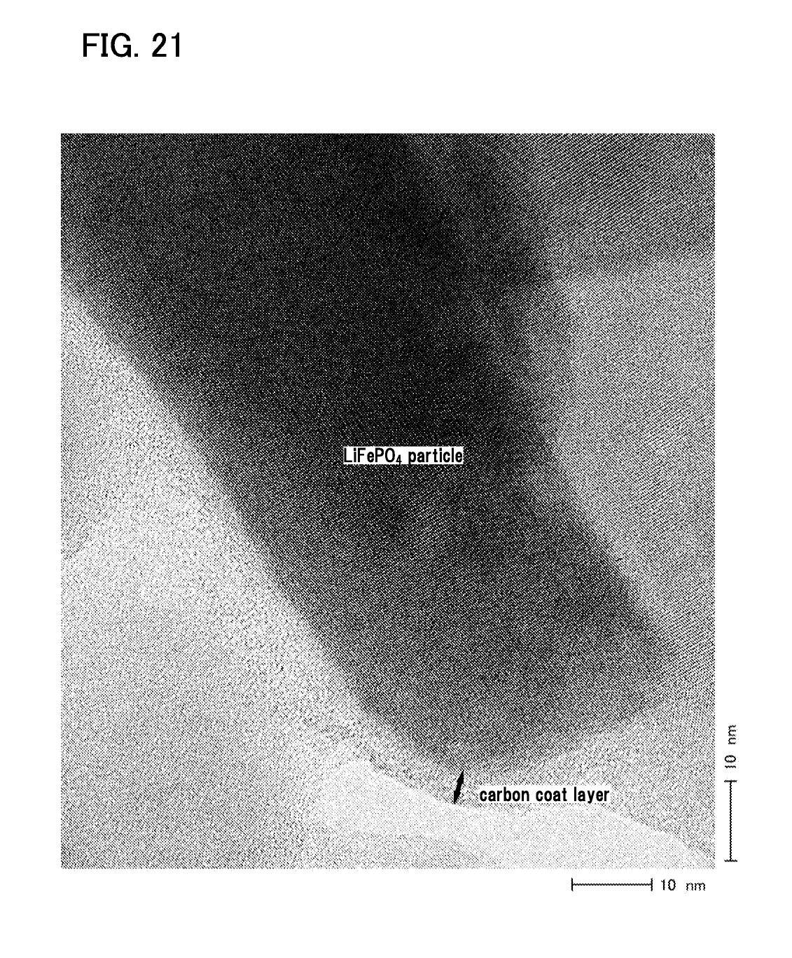

FIG. 21 is a cross-sectional TEM image of the vicinity of the surface of the LiFePO₄ particle included in the positive electrode taken out of the storage battery 1 (observed at an accelerating voltage of 200 kV and at an observation magnification of 2,050,000 times). In the observation image of FIG. 21, an amorphous layer was not formed on the surface of LiFePO₄ particle, unlike in the observation image of FIG. 20. Therefore, it is found that the positive electrode active material did not react with the electrolyte solution, and did not deteriorate by such a reaction.

The storage battery 1 of one embodiment of the present invention has an improved cycle life because the positive electrode active material does not deteriorate.

### Example 2

In this example, a storage battery of one embodiment of the present invention was fabricated on the basis of Embodiment 1, and subjected to a charge and discharge test in which the environmental temperature was changed. The temperature characteristics were obtained. That is, whether the storage battery normally operates even at a low temperature of 0° C. or not was verified.

### <Structure of Storage Battery 2>

The structure of the fabricated storage battery 2 will be described.

### [Formation of Positive Electrode C]

First, a positive electrode slurry containing graphene as a conductive additive was formed. Lithium iron phosphate (LiFePO₄) was used as a positive electrode active material, and polyvinylidene fluoride (PVdF) was used as a binder. Lithium iron phosphate, graphene oxide, and polyvinylidene fluoride were mixed at a weight ratio of 94.2:0.8:5.0. Then, N-methyl pyrrolidone (NMP) was added as a dispersion medium to adjust the viscosity, and mixing was performed. Thus, the positive electrode slurry was formed.

The positive electrode slurry formed by the above method was applied to a positive electrode current collector (20-μm-thick aluminum).

Subsequently, the slurry provided on the current collector was dried with a circulation dryer. The drying was performed in an air atmosphere at 80° C. for 40 minutes.

Subsequently, graphene oxide was reduced by reaction in a solvent containing a reducer. The reduction treatment was performed at 60° C. for 1 hour. Ascorbic acid was used as the reducer. As the solvent, NMP was used. The concentration of the reducer was 13.5 g/L.

After that, cleaning with ethanol was performed, and drying was performed at 170° C. for 10 hours. The drying was performed in a vacuum atmosphere. Note that this step also serves as thermal reduction of graphene oxide

Subsequently, the positive electrode active material layer was pressed by a roll press method so as to be consolidated.

A positive electrode C used for the storage battery 2 was formed in the above manner. The amount of lithium iron phosphate in this positive electrode was 10.6 mg/cm².

### [Formation of Negative Electrode C]

For graphite of a negative electrode active material, graphite which is modified with silicon oxide was formed. Artificial graphite (MCMB) with a grain diameter of 10 μm was used as the graphite. The modification of artificial graphite was performed twice by a spray dry method using ethyl silicate as a coating and using silicon oxide whose amount was 1 wt % with respect to the artificial graphite. As a conductive additive, VGCF (registered trademark)-H (manufactured by SHOWA DENKO K.K., the fiber diameter: 150 nm, the specific surface area: 13 m²/g) was used. A negative electrode slurry was formed with the use of the artificial graphite formed by the above method, the conductive additive, a binder, and a dispersion medium. As the binder, sodium carboxymethyl cellulose (CMC-Na) and styrene butadiene rubber (SBR) were used. Water was used as the dispersion medium of the slurry. The negative electrode slurry was obtained in such a manner that the artificial graphite, VGCF (registered trademark), CMC-Na, and SBR were mixed in water so that the weight ratio thereof was 96:1:1:2.

The negative electrode slurry formed by the above method was applied to a negative electrode current collector (18-μm-thick rolled copper foil).

Subsequently, drying on a hot plate was performed in an air atmosphere. The drying step was started at 25° C. to 30° C., and the temperature was then raised to 70° C. or lower and kept for approximately 30 minutes, so that water, i.e., the dispersion medium was evaporated. After that, drying was performed at 100° C. in a reduced pressure environment for 10 hours.

The negative electrode C used for the storage battery 2 was formed in the above manner. The amount of graphite in this negative electrode was 9.7 g/cm².

The electrolyte solution A in which a lithium salt was LiTFSA was used. For the electrolyte solution, EC and DEC were mixed at a volume ratio of 1:1 so as to be a solvent, and LiTFSA was dissolved as the lithium salt at a concentration of 0.65 mol/kg. Then, 2 wt % of LiPF₆ and 1 wt % of VC were added as additives.

### [Fabrication of Storage Battery 2]

A laminated storage battery was fabricated with the use of the formed positive electrode C, negative electrode C, and electrolyte solution A. An aluminum film covered with a heat sealing resin was used as an exterior body. As a separator, 25-μm-thick polypropylene (PP) was used. The laminated storage battery is a storage battery 2.

Next, the fabricated storage battery 2 was subjected to aging through the process similar to that of the storage battery 1.

### <Temperature Characteristics of Storage Battery 2>

Temperature characteristics of the storage battery 2, which was prepared in the above manner, were obtained. Charge and discharge measurement was performed as follows. First, the storage battery 2 was charged to 4.0 V at 25° C., and then discharged to 2.0 V at 0° C. Next, the storage battery 2 was charged to 4.0 V at 25° C., and then discharged to 2.0 V at 25° C. Finally, the storage battery 2 was charged to 4.0 V at 25° C., and then discharged to 2.0 V at 60° C. Charge and discharge were performed at a rate of 0.2 C. Charge and discharge were performed at a constant current (CC).

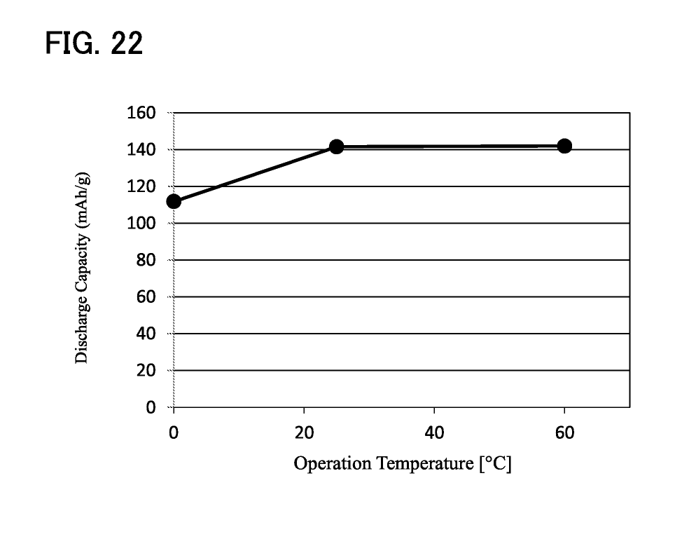

FIG. 22 shows the obtained temperature characteristics. The discharge capacity at 0° C. is 76% of the discharge capacity at 25° C. This indicates that the storage battery of the present invention normally operates even at a low temperature of 0° C.

This application is based on Japanese Patent Application serial no. 2014-217667 filed with Japan Patent Office on Oct. 24, 2014, the entire contents of which are hereby incorporated by reference.

What is claimed is:

1. A lithium-ion storage battery comprising:
a positive electrode;
a negative electrode; and
an electrolyte solution,
wherein the positive electrode includes an active material and a plurality of graphenes,
wherein the active material includes a metal, and
wherein the electrolyte solution includes at least one of LiTFSA and LiFSA.

2. The lithium-ion storage battery according to claim 1,
wherein the positive electrode includes a current collector, and
wherein the current collector includes Al.

3. The lithium-ion storage battery according to claim 1,
wherein the electrolyte solution further includes LiPF₆, and
wherein a concentration of LiPF₆ to the electrolyte solution is more than 0 wt % and less than or equal to 10 wt %.

4. The lithium-ion storage battery according to claim 1,
wherein the metal is not observed from a surface of the negative electrode by an X-ray photoelectron spectroscopy analysis.

5. The lithium-ion storage battery according to claim 1,
wherein the metal is any one of Fe, Co, Ni, and Mn.

6. A lithium-ion storage battery comprising:
a positive electrode;
a negative electrode; and
an electrolyte solution,
wherein the positive electrode includes an active material and a plurality of graphenes,
wherein the active material includes a metal, and
wherein the electrolyte solution includes Li, N, F, S, O, P and C.
